(19) United States
(12) Patent Application Publication
(10) Pub. No.: US 2017/0216667 A1
(43) Pub. Date: Aug. 3, 2017

(54) ESPORTS FITNESS AND TRAINING SYSTEM

(71) Applicant: GAMING GRIDS WEARABLES, LLC, LAS VEGAS, NV (US)

(72) Inventors: DANA GARVEY, TORRANCE, CA (US); GARY WEINGARDT, LAS VEGAS, NV (US); GAMIN WEINGARDT, LAS VEGAS, NV (US)

(73) Assignee: GAMING GRIDS WEARABLES, LLC, LAS VEGAS, NV (US)

(21) Appl. No.: 15/410,343

(22) Filed: Jan. 19, 2017

Related U.S. Application Data
(60) Provisional application No. 62/290,302, filed on Feb. 2, 2016.

(51) Int. Cl. A63B 24/00; G09B 19/00; A63F 13/85; A63B 71/06

(52) U.S. Cl. CPC A63B 24/0062; A63B 71/0622; A63B 24/0003; G09B 19/0092; A63F 13/85; A63B 2024/0065; A63B 2225/50; A63B 2225/20; A63B 2220/40; A63B 2230/06; A63B 2230/70; A63B 2220/803; A63B 2220/836

(57) ABSTRACT

An eSports fitness band and system are disclosed. The eSports fitness band may be worn by the user. The eSports fitness band uses sensors to calculate user activity data and output the data via BLUETOOTH® wireless technology to the user's mobile electronic device. The user's mobile electronic device then transmits the user's fitness data to a cloud data repository. Data from the user's video game play and use of gymnasium equipment may also be captured and transmitted to the cloud data repository. The user's fitness data may then be compiled with the user's video game play metrics or with the user's gym data. The compiled data may then be accessed by the user via his computer and can be exported for inclusion in a video stream or content delivery network.

### CROSS-REFERENCE TO RELATED APPLICATION

The present patent application claims priority to U.S. Provisional Application No. 62/290,302, entitled “eSports Fitness Band,” which was filed on Feb. 2, 2016 in the name of at least one of the inventors herein, and which is incorporated in full herein by reference.

### TECHNICAL FIELD

This invention relates generally to activity trackers, and more particularly to an activity monitoring device and system that monitors a user's various activities, including a user's proficiencies while playing video games and their association with physical fitness activities.

### BACKGROUND

A plethora of activity monitoring devices has been marketed in previous years, those of which monitor varying physical data. Those devices determine such items as step counts, heart rates, and varying other data points of biometric information. In some cases, global positioning information is entered and registered in order to determine distance equivalents and terrain modeling. However, none of those activity monitoring devices or systems currently track the user's online performance for specific sports or correlate that performance information with real world activity in the user's daily life. The interactions of online activity and real world activity are currently extremely intertwined. Therefore, due to this meshing of activities the embodiments disclosed herein arise.

An eSport is a multiplayer video game played competitively for spectators, typically by professional gamers. The present invention is an activity monitoring device and system for eSports fitness that comprises an eSports fitness band that has a physical housing designed to be worn by the user in which the device incorporates several technologies and sensors into the housing of said device. Such technologies are driven by sensors, such as gyroscopes, accelerometers, step counters, heart rate sensing, and Near Field Communication (NFC) technologies. These sensors calculate user activity data and output the data via BLUETOOTH® short range wireless technology. The present device may also incorporate a display screen in either touchscreen or light-emitting diode (LED) modes. The present device may also incorporate specific processing methods via circuitry, integrated circuit (IC) chips, and controllers. In some use cases NFC technology is employed to directly target the location of the user and NFC-tagged equipment, such as computer locations at local area network (LAN) locations during eSports events, gymnasium equipment and/or intelligent weight scales, in order to provide additional biometric data points. Data from video game play may also captured and compiled in order to ascertain the user's proficiencies while playing video games and their association with physical fitness activities.

### SUMMARY OF THE INVENTION

This summary is provided to introduce a selection of concepts of the present invention in a simplified form that are further described in detail below in the DETAILED DESCRIPTION OF THE INVENTION. This summary is not intended to identify each and every key feature of the invention, which remains the exclusive purview of claims, nor is the Summary intended to be used as an aid in determining the scope of the claimed subject matter.

The embodiments disclosed herein relate to devices, systems, programs, methods, and computer processes for consolidating and analyzing data from multiple data sources. This includes segregated and overlapping data from multiple incoming data streams, physiological data, and related video game summary data. The data sources are combined to produce an overall performance scoring of the users' proficiencies in a plurality of predefined target goals as represented by percentages in each individual metric of that particular classification. The eSports fitness band is comprised of several sensors to receive the required biometric data.

In another embodiment, methods are inclusive of tracking and receiving data from a plurality of other biometric sources, thus creating a defined user stream of historical data.

In another embodiment, methods are inclusive of tracking and storing online video game play data for the user for a single or plurality of video games in order to combine the video game play data with the user's physical data streams, thus creating a defined user stream of historical data.

In another embodiment, methods are inclusive of relating the user's physical data streams and timing data streams from actual physical gymnasium and health and fitness related equipment and from activities such as golf, disc golf, basketball, football, baseball etc. These data streams would be acquired by use of Radio Frequency Identification (RFID) and/or NFC short range wireless technologies in order to determine time of use, location, and type of a plurality of such equipment and activities.

In accordance with one embodiment of the present invention, an eSports fitness and training system is disclosed. The system comprises: a cloud data repository; a wearable activity tracking device having: a plurality of sensors contained therein, wherein the plurality of sensors generate physical fitness data of a user; a processor; a memory for storing the physical fitness data of the user; and a short range wireless communication device for transmitting the physical fitness data of the user according to a Bluetooth wireless protocol; a near field communication (NFC) chip for transmitting the physical fitness data of the user according to a NFC wireless protocol; a video game platform that generates user game play data as the user plays a video game on the video game platform and that transmits the user game play data to the cloud data repository; an exercise device that generates user gym data as the user exercises on the exercise device and that transmits the user gym data to the cloud data repository, wherein the exercise device has an NFC reader to receive the physical fitness data of the user according to the NFC wireless protocol; and a mobile electronic device having: a processor for executing a mobile software application that allows the user to input nutritional data; a memory for storing the mobile software application; and a short range wireless communication device to communicate with the short range wireless communication device of the wearable activity tracking device to receive the physical fitness data of the user according to the Bluetooth wireless protocol; and a wireless communication device to transmit the physical fitness data and the nutritional data to the cloud data repository; wherein the physical fitness data, the nutritional data, and the game play data are transmitted from the cloud data repository to a computer for use in a customized video stream, wherein the customized video stream comprises an overlay that is superimposed over underlying images of the video game that the user is playing, and wherein the overlay contains at least one of the physical fitness data of the user and the nutritional data of the user.

In accordance with another embodiment of the present invention, an eSports fitness and training system is disclosed. The system comprises: a cloud data repository; a wearable activity tracking device having: at least one of an internal measurement unit (IMU) gyroscope and an accelerometer, wherein the at least one of the IMU gyroscope and an accelerometer generates motion sensor data of a user; a processor; a memory for storing the motion sensor data of the user; and a short range wireless communication device for transmitting the motion sensor data of the user according to a Bluetooth wireless protocol; a near field communication (NFC) chip for transmitting the motion sensor data of the user according to a NFC wireless protocol; a video game platform that generates user game play data as the user plays a video game on the video game platform and that transmits the user game play data to the cloud data repository; and a mobile electronic device having: a processor for executing a mobile software application; a memory for storing the mobile software application; and a short range wireless communication device to communicate with the short range wireless communication device of the wearable activity tracking device to receive the motion sensor data of the user according to the Bluetooth wireless protocol; and at least one of a wired communication device and a wireless communication device to transmit the motion sensor data to the cloud data repository.

In accordance with another embodiment of the present invention, an eSports fitness and training system is disclosed. The system comprises: a cloud data repository; a wearable activity tracking device having: at least one sensor contained therein, wherein the at least one sensor generates at least one of physical fitness data and motion sensor data of a user; a processor; a memory for storing the at least one of the physical fitness data and the motion sensor data of the user; and a short range wireless communication device; a video game platform that generates user game play data as the user plays a video game on the video game platform and that transmits the user game play data to the cloud data repository; and a mobile electronic device having: a processor for executing a mobile software application that allows the user to view the at least one of the physical fitness data and the motion sensor data of the user; a memory for storing the mobile software application; a short range wireless communication device to communicate with the short range wireless communication device of the wearable activity tracking device to receive the at least one of the physical fitness data and the motion sensor data of the user; and at least one of a wired communication device and a wireless communication device to transmit the at least one of the physical fitness data and the motion sensor data to the cloud data repository.

In accordance with another embodiment of the present invention, a method for tracking eSports fitness data is disclosed. The method comprises the steps of: receiving physical fitness data of a user, by a wearable activity tracking device that is worn by the user, wherein the wearable activity tracking device receives the physical fitness data from a plurality of sensors contained therein; transmitting the physical fitness data from the wearable activity tracking device through a short range wireless communication device of the wearable activity tracking device according to a Bluetooth wireless protocol; receiving the physical fitness data, by a mobile electronic device through a short range wireless communication device according to the Bluetooth wireless protocol; receiving nutritional data, by the mobile electronic device, wherein the nutritional data is input by the user through one of input keys and a touchscreen of the mobile electronic device; transmitting the physical fitness data and the nutritional data from the mobile electronic device to a cloud data repository via a wireless communication device; receiving by the cloud data repository, the physical fitness data and the nutritional data; receiving by the cloud data repository, game play data from a video game platform on which the user is playing a video game; transmitting the physical fitness data, the nutritional data, and the game play data by the cloud data repository to a computer; creating a customized video stream on the computer wherein the customized video stream comprises an overlay that is superimposed over underlying images of the video game that the user is playing, and wherein the overlay contains at least one of the physical fitness data of the user and the nutritional data of the user; and streaming the customized video stream on the Internet.

In accordance with another embodiment of the present invention, a method for tracking eSports data of a user is disclosed. The method comprises the steps of: receiving at least one of physical fitness data and motion sensor data of the user, by a wearable activity tracking device that is worn by the user, wherein the wearable activity tracking device receives the at least one of the physical fitness data and the motion sensor data from at least one sensor contained therein; transmitting the at least one of the physical fitness data and the motion sensor data from the wearable activity tracking device through a short range wireless communication device of the wearable activity tracking device; receiving the at least one of the physical fitness data and the motion sensor data, by a mobile electronic device through a short range wireless communication device that communicates with the short range wireless communication device of the wearable activity tracking device; receiving nutritional data by the mobile electronic device, wherein the nutritional data is input by the user through one of input keys and a touchscreen of the mobile electronic device; transmitting the at least one of the physical fitness data and the motion sensor data from the mobile electronic device to a cloud data repository via at least one of a wired communication device and a wireless communication device; transmitting the nutritional data from the mobile electronic device to the cloud data repository via the at least one of the wired communication device and the wireless communication device; receiving by the cloud data repository, the at least one of the physical fitness data and the motion sensor data; receiving by the cloud data repository, the nutritional data; receiving by the cloud data repository, game play data from a video game platform on which the user is playing a video game; and transmitting the nutritional data, the game play data, and the at least one of the physical fitness data and the motion sensor data by the cloud data repository to at least one of a user viewable website portal and a computer for creating a customized video stream that is streamed on the Internet.

In accordance with another embodiment of the present invention, a method for tracking eSports data of a user is disclosed. The method comprises the steps of: receiving at least one of physical fitness data and motion sensor data of the user, by a wearable activity tracking device that is worn by the user, wherein the wearable activity tracking device receives the at least one of the physical fitness data and the motion sensor data from at least one sensor contained therein; transmitting the at least one of the physical fitness data and the motion sensor data from the wearable activity tracking device through a short range wireless communication device of the wearable activity tracking device; receiving the at least one of the physical fitness data and the motion sensor data, by a mobile electronic device through a short range wireless communication device that communicates with the short range wireless communication device of the wearable activity tracking device; transmitting the at least one of the physical fitness data and the motion sensor data from the mobile electronic device to a cloud data repository via at least one of a wired communication device and a wireless communication device; receiving by the cloud data repository, the at least one of the physical fitness data and the motion sensor data; receiving by the cloud data repository, game play data from a video game platform on which the user is playing a video game; and transmitting the game play data and the at least one of the physical fitness data and the motion sensor data by the cloud data repository to at least one of a user viewable website portal and a computer for creating a customized video stream that is streamed on the Internet.

### BRIEF DESCRIPTION OF THE DRAWINGS

Embodiments of the disclosure will become more fully understood from the detailed description and the accompanying drawings, wherein:

FIG. 1 shows an eSports fitness system in accordance with one or more embodiments of the present invention;

FIG. 1B is a perspective view of an eSports fitness band in accordance with one or more embodiments of the present invention.

FIG. 2 is a diagram showing the components of the eSports fitness system of FIG. 1 and the data flow between them;

FIG. 3 is a circuit diagram for a bioimpedance sensor for use with the system of FIG. 1;

FIG. 4 is a circuit diagram for an internal measurement unit (IMU) gyroscope for use with the system of FIG. 1;

FIG. 5 is a diagram showing the data flow from all components in the eSports fitness system of FIG. 1 and their respective interconnections within the data stream;

FIG. 6 is a diagram showing the gymnasium sectors of the e-sport fitness band in accordance with one or more embodiments of the present invention and its data flow in gymnasium related applications;

FIG. 7 is a diagram showing the data flow of the IMU gyroscope and its association with data being processed for calorie burn calculations;

FIG. 8 is a diagram showing the data flow and data points captured for determination of the user's calorie burn rates during particular activities, such as walking, sleeping, and exercising;

FIG. 9 is a diagram showing the data flow from the IMU gyroscope and the optical heart rate sensor wherein the calorie burn ratios are determined by the user's heart rate;

FIG. 10 is a diagram showing the action key input of liquid ingestion by the user;

FIG. 11 is an exemplary screen shot of a carousel feature where the user will choose a video game title from several displayed video game titles, wherein the video game metrics of the selected video game will be tracked by the eSports fitness system;

FIG. 12 is an exemplary screen shot of a custom overlay feature that allows the user to change to a viewable environment that will be digitally streamed to viewers;

FIG. 13 is an exemplary screen shot wherein the user may choose which of his physical metrics will be shown to the viewer of the digital stream;

FIG. 14 is an exemplary screen showing the preview sections from a user view;

FIG. 15 is an exemplary screen shot wherein all features and customizations have been employed by the user;

FIG. 16 is a diagram showing the interconnectivity of only the gymnasium NFC embedded equipment and associated electronic exercise devices as they connect to the eSports fitness band;

FIG. 17 is a diagram showing an exemplary player leveling scenario;

FIG. 18 is a diagram showing exemplary player leveling mobile screen shots;

FIG. 19 shows the rotation and orientation in the X, Y and Z axes of a user's wrist;

FIG. 20 shows the different positions of the user's hand and wrist;

FIG. 21 is a diagram showing the data flow and data points captured for tracking the activity data from a remote device and the fitness data of the user;

FIG. 22 is a diagram showing the angular ratios of a remote device; and

FIG. 23 is a diagram showing the data flow and data points captured for tracking movement of the user's wrist for controlling a video game.

### DETAILED DESCRIPTION OF THE INVENTION

The description set forth below in connection with the appended drawings is intended as a detailed description of presently known exemplary embodiments of the disclosure and is not intended to represent the only forms in which the present invention can, may, or could be constructed and/or utilized. The detailed description sets forth the functions and the sequence of the steps for constructing and operating the disclosure in connection with the illustrated embodiments as well as the best mode of carrying out the invention. It is to be understood, however, that the same or equivalent functions and sequences can be accomplished by different exemplary embodiments that are also intended to be encompassed within the spirit and scope of this invention.

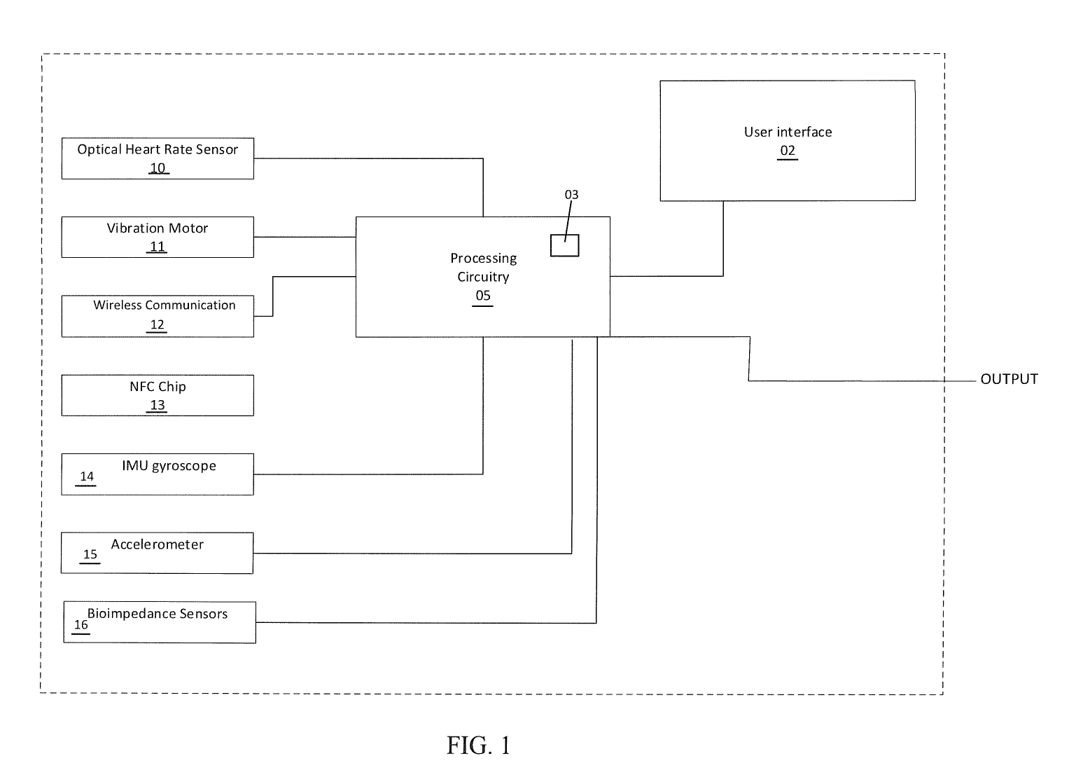

FIGS. 1-23 together disclose an eSports fitness band 102 and related eSports fitness and training system 100. The eSports fitness band 102 is a wearable activity tracking device that may be used to gather/generate physical fitness data 34 and/or activity data 43 of the user in relation to all activities that he performs, such as but not limited to caloric intake, video game 32 metrics, exercise, walking, running, weight lifting, cycling, football, baseball, disc golf, etc.

The eSports fitness band 102 may be worn on the user's wrist and it will gather all the needed information for the fitness data 34 from its incorporated electronic sensors (e.g IMU gyroscope, heart rate sensor, etc.) and store them on the on board memory 03 of the eSports fitness band 102 until a synchronization process transfers that information via a wireless communication device/protocol (e.g. BLUETOOTH®) to the user's mobile electronic device 18 (e.g. smartphone). The mobile electronic device 18 will use its processor to execute software applications that are stored in the memory of the user's mobile electronic device 18 to transmit all of the data to the cloud data repository 22 for analytics and for display on the user's web portal 23 and/or on software applications residing on the user's computer 24. The user's mobile electronic device 18 will have transmitter and receiver circuits (transceiver circuits) which use one or more communication protocols/systems (either wired or wireless) to transmit data to and receive data from other devices and/or networks.

The eSports fitness band 102 data stream is inclusive of all compiled data by the eSports fitness band 102 and thus emitted through wireless communication technology (e.g. BLUETOOTH®) to the associated mobile application stored on the user's mobile electronic device 18. The user's mobile electronic device 18 will have wireless transmitter and receiver circuits that will use the wireless communication technology/protocols to receive the compiled data stored on the eSports fitness band 102 memory 03 and transmit them to the cloud data repository 22. The user's mobile electronic device 18 will contain and host the proprietary mobile application for the initial repository of information in a Generic User Interface format for the user to review and edit the compiled information. Data may then be transferred via cellular data connection or WI-FI® connection to the main secure storage located on the cloud data repository 22. The user may choose to review the stored information on the cloud data repository 20 via HTML on a personal computer 24.

Users may choose to export data via a proprietary application that is housed and hosted on the user's computer 24. This export method would then allow for customization of the exported data for inclusion into a customized overlay 30 in which the data will be exported after being formatted correctly for inclusion in a video stream and/or content delivery network. The customized overlay 30 will encompass the users' physical fitness data 34 that was gathered from the eSports fitness band 102 and formatted to be superimposed over the images of the video game 32 so that video game 32 media content can be seen under the customized overlay 30. The customized overlay 30 will also contain additional user data options for display on the user's system and through the user's streaming accounts (e.g. TWITCH®, HITBOX®, YAHOO® games, etc.) such as programming hotkeys and multiple profile options.

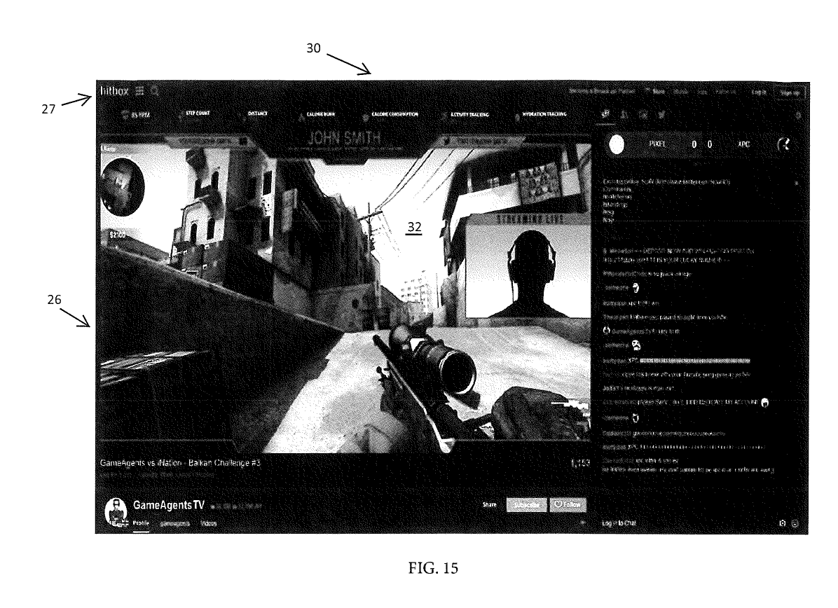

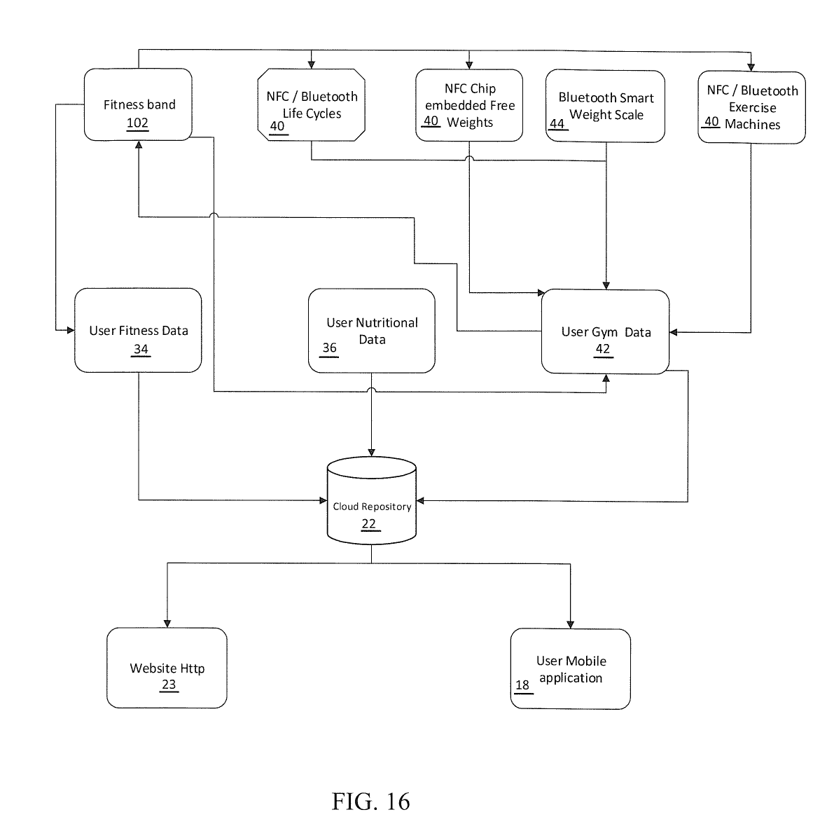

The software application that resides on the user's desktop/laptop computer 24 may gather all available and registered statistical data from the user's video game 32 play data 38 of video games 32 that the user has registered with the system 100. This statistical data is then compiled, and though proprietary algorithms, a synopsis of all statistical data is provided to the user via graphical and numerical displayed data points. These data then are used to provide the user benchmarks of performance against other users and additional performance benchmark targets for the user to attain that will assist the user in attaining greater performance through physical activity to achieve better performance in the activities of video game 32 play (see FIGS. 16-17).

The above-mentioned metrics for video game 32 play enhancement are achieved by the gathering of the statistical data of video game 32 play such as movement, kills, attacks, deaths, in-game achievements, and all other available data points of in-game performance. This data after post-compilation is compared to the user's physical fitness data 34 graphs and nutritional data 36 that has been gathered via the eSports fitness band 102 and stored in the cloud data repository 22. Through proprietary algorithms the data is verified and leveled to produce the final readings and findings on performance and performance enhancements.

The user, also through the use of the proprietary accompanying software, may also stream these metrics from the user's computer 24 systems onto social media outlets and other content streaming websites.

In one embodiment, the user may use his computer 24 to connect to the Internet via wired or wireless communication systems/protocols and to log into his account on the system's 100 computer-based portal 23 and access the system 100. The user may then choose from a variety of video game 32 options and proceed to the customization phase or sections of the application in order to select from a variety of options and display metrics for the streaming of content. Once that is completed, the system 100 will create and embed the chosen overlay 30 onto the desired video game 32 stream. Screen captures and other options may also be available for social media sharing.

FIG. 1 shows an eSports fitness system 100 in accordance with one or more embodiments of the present invention. As shown, the eSports fitness system 100 may comprise an eSports fitness band 102 (see FIG. 1B). The eSports fitness band 102 may have a user display interface 02, an on board memory 03, computer-readable media/software that is stored in the on board memory 03 and contains instructions for carrying out one or more functions of the system 100, processing circuitry 05 for executing the software, a plurality of sensors, and output processes. The output processes are those processes that take the collected information that is stored onto the on board memory 03 of the eSports fitness band 102 and wirelessly transmits the relevant data to the user's mobile device 18. The eSports fitness band 102 will have one or more sensors located within its casing so that the processor 05 of the eSports fitness band 102 may receive fitness data 34 from those sensors. The sensors may include an optical heart rate sensor 10, an IMU gyroscope 14, an accelerometer 15, and a bioimpedance sensor 16. It should be clearly understood that substantial benefit may be obtained from the use of other types of sensors and from those sensors being located outside of the eSports fitness band 102. Within the casing of the eSports fitness band 102 there may also be a vibration motor 11, BLUETOOTH® short range wireless communication protocols 12 which are programmed into the on board memory 03, and an NFC chip 13. The NFC chip 13 may have its own incorporated rewritable memory and may communicate wirelessly with NFC-tagged equipment via separate NFC RFID (Near Field Communication Radio-Frequency IDentification) readers and software. Where NFC short range wireless communication devices/protocols are used, the eSports fitness band 102 will have an NFC chip 13 which communicates with an NFC reader or receiver that is contained in exercise devices such as gymnasium equipment 40 or a smart weight scale 44.

FIG. 1B shows an embodiment of the eSports fitness band 102 that may be used with the system 100 of the present invention. The eSports fitness band 102 may be transparent so that the compartments for the internal components of the eSports fitness band 102 may be visible. The eSports fitness band 102 may have a user interface 02 that may be displayed on an organic light-emitting diode (OLED) display. The eSports band 102 may incorporate OLED technology both in flexible and non-flexible technologies. This would allow for specific curvatures to be attained by the eSports band 102, which may be helpful for fitting the eSports band 102 to the specific user's body shape. The OLED display may incorporate touch screen technologies so that the user may use his finger to maneuver through the associated menus shown in the user interface 02. This will allow the user to easily scroll through and select different options available to them in the system 100.

The eSports fitness band 102 also has a processor 05 for implementing software that is stored on the on board memory 03. The processor 05 serves as the central point for induction of all relevant information supplied by the eSports fitness band's 102 biometric sensor arrays.

The eSports fitness band 102 may also incorporate a vibration motor 11 that will silently notify the user of certain alarms and notifications being received by the eSports fitness band 102. The vibration motor 11 may be installed in an encasement of a main electronic housing of the eSports fitness band 102. The vibration motor 11/motor driver shall be as or similar.

The eSports fitness band 102 may receive data from an optical heart rate sensor 10. The eSports fitness band 102 uses optical heart rate sensing through the use of photo plethysmography (PPG). Heart rate data is then produced from the combined data sources of the optical heart rate sensor's 10 optical emitter, digital signal processor, the accelerometer and, through proprietary algorithms, motion tolerant heart rate data is produced for display and data storage in the user(s) real-time and historical profile. Even with the technology used in the eSports fitness band 102, there are varying factors that increase or decrease the accuracy of the PPG readings, such as optical noise, skin tone of the user, sensor location, and low perfusion. The items are compensated for in the optomechanics dealing with the correct wavelengths for the specified body location, optomechanical coupling to reduce sunlight, multiple emitters, emitter spacing, gross displacement between sensor and skin area, and signal extraction algorithms.

The eSports fitness band 102 may also have short range wireless communication devices/protocols 12, such as BLUETOOTH® 4.0 or the like. The wireless communication protocols 12 may be incorporated into the system 100 with sync ranges of approximately twenty feet. This type of wireless communication protocols 12 will help provide secure communication from the eSports fitness band 102 to the user's mobile electronic device 18 (e.g. cellular phone) in order to update the user's data that is gathered from the sensor arrays on the eSports fitness band 102 and stored in the eSports fitness band's 102 on board memory 03.

Near Field Communication wireless communication protocols may be incorporated into the eSports fitness band 102 in order to create a wireless link to NFC readers that are located in such areas as gymnasiums, video game 32 tournaments online and live events and their associated access points. Use of the NFC technology will allow the eSports fitness band 102 and its associated software to compile information regarding the user as to time of use on certain NFC tagged physical training equipment (e.g. workout cycles, weight benches, lifecycles, rowing machines, etc.). In addition, NFC readers on intelligent weight scales 44 may also be used to register the user's additional biometric data, such as the user's weight and body mass index. The eSports fitness band 102 software will then compile and release leveled and summed data regarding the user.

Additionally, the NFC chip 13 incorporated in the eSports fitness band 102 may be used to connect with additional reading sensors to locate seated positions in eSports events for additional activities. Regarding eSports events, a player may qualify for a LAN event after concluding an online video game tournament event. A player typically arrives at a physical stadium/arena/event center and scans into the eSports system and is therefore assigned a seating position in the LAN event. The player may tag into the computer located at a certain seat location and verify his location; i.e. the seat location may be equipped with an NFC tag that will communicate with the NFC chip 13 within the eSports fitness band 102. As the LAN event continues, players can log into other seats and be tracked as to their position at the LAN event. Due to the fact that players move around during these contests, tracking of such movement is imperative. The player, who is wearing the eSports fitness band 102, may log into their specified seating location in the eSports arena via the NFC chip 13 and be tracked by the system 100 as to his location, seat assignment, etc. in the LAN gaming center/arena. Also, this allows online tournament providers who create these eSports events to pre-assign area seating and thus reduce the need for additional personnel at the eSports event. The NFC tagging and assignment would be controlled by the same computer software program that is incorporated in the eSports fitness band 102 software and it would be stored and executed on the memory and processor of the computer(s) that is hosting the LAN event. A computerized model of the LAN event center and its seating may be displayed via the software and by clicking on any seat in the computerized model, a viewer would be able to see the player's information.

An IMU gyroscope 14 may be used with the eSports fitness band 102. A six-axis accelerometer/gyroscope may be used to perform nine-axis motion fusion algorithms. This will allow for elevation and arm tracking of the user for certain applications and for precision tracking of both fast and slow motions made by the user. The IMU gyroscope 14 may feature a user-programmable gyroscope with a full-scale range of ±250, ±500, ±1000, and ±2000°/sec (dps), a user-programmable accelerometer with a full-scale range of ±2 g, ±4 g, ±8 g, and ±16 g, and a compass with a full-scale range of ±1200 μT.

The eSports fitness band 102 may also use temperature sensors to provide temperature readings via a 16-bit signed value representing the internal device temperature.

The eSports fitness band 102 may also have an accelerometer 15 that may be used for distance measurement. Single-axis or multi-axis accelerometers 15 may be used to measure the user's direction, proper acceleration, step recognition, and gesture recognition. Based on step count provided by accelerometer 15 measurements, the total distance traveled will be summed using the base calculation of an average stride length of 32 inches. For example:

d=\sqrt{(x₂−x₁)²+(y₂−y₁)²}

For step counts, the eSports fitness band 102, via sensor data from the accelerometer 15, will calculate the amount of steps of the fitness user wearer using the following equation sample, where a=acceleration; v=velocity; and t=time

a=Δv/Δt=(v_{f}−vᵢ)/(t_{f}−tᵢ)

This calculation is driven by the motion of the users arm in the forward and reverse directions as the user moves from point to point.

Bioimpedance sensors 16 may also be used to measure the user's heart rate, stress levels, respiration rate, and other user physiologic data points. The bioimpedance sensor 16 measures the resistance of body tissue through the use of small electrical currents between the sensors in order to calculate physiologic signals that provide the required information when placed correctly on the users' wrist.

The eSports fitness band 102 may also have water-proofing qualities. For example, the eSports fitness band 102 may adhere to water proofing standards in accordance with the IP Code, which classifies and rates the degree of protection provided against intrusion, dust, accidental contact, and water by mechanical casings and electrical enclosures. It is preferable that the eSports fitness band 102 of the present invention have ratings of IP67, and in some cases IP68. This will allow the submersion of the eSports fitness band 102 into water or another liquid without compromising the internal electronics encased/contained within it. This would allow the user to swim with the eSports fitness band 102 in depths of up to ten meters.

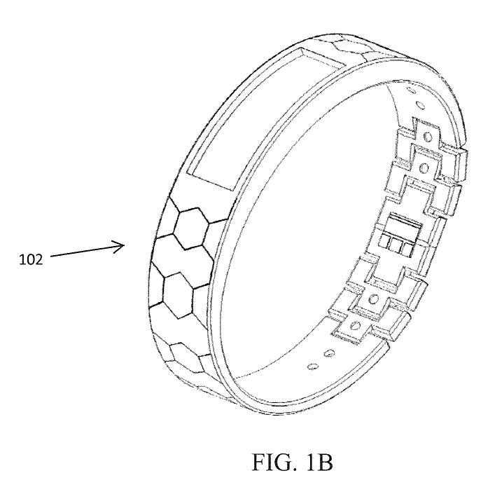

FIG. 2 is a dataflow overview that shows the interconnectivity between each of the segregated physical elements of the overall system 100 components. It also portrays the communication directions of user compiled information and the display of such information from its particular component. Specifically, data about the user of the eSports fitness band 102 is gathered by the eSports fitness band 102. Data is transmitted from the eSports fitness band 102 to the user's mobile electronic device 18. Data is then transmitted from the user's mobile electronic device 18 via wireless Internet communication technology/protocol (e.g. WIFI®) through web services 20 to a cloud data repository 22 where it is stored. Data that is stored in the secure cloud data repository 22 may also be accessed through web services 20.

The user may have a computer 24 on which the user may play one or more video games 32. The user may also wish to broadcast or live stream his video game 32 play over the Internet through web services 20 and may employ streaming media 27, such as TWITCH®, HITBOX®, AZUBU® and the like to do so. Data from the eSports fitness band 102 may be transmitted to the user's computer 24 through web services 20. The user may then create a customized video game 32 play video stream 26 which includes the data received from the eSports fitness band 102. The streaming media 27 may then display the user's customized video stream 26, which shows the user's data from the eSports fitness band 102 overlaid onto and synchronized with the underlying base video game 32 that the user is playing. The result is that third parties may use their electronic devices to view the customized video stream 26 where they can see the user's statistics (e.g. heart rate, calorie burn, etc.) while he is playing the video game 32.

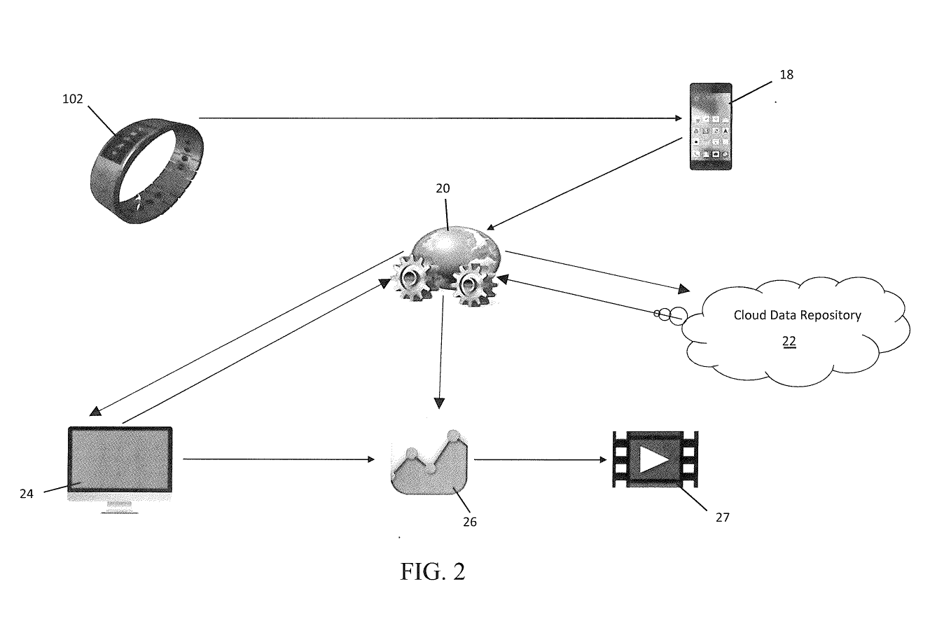

FIG. 3 shows an electrical schematic of the bioimpedance sensor 16 and its electronic components that are located on the eSports fitness band 102 circuit board. It should be clearly understood that this is one example of the circuit design for the portion of the printed circuit board that encompasses the bioimpedance sensor 16 and that substantial benefit may be derived from an alternative configuration.

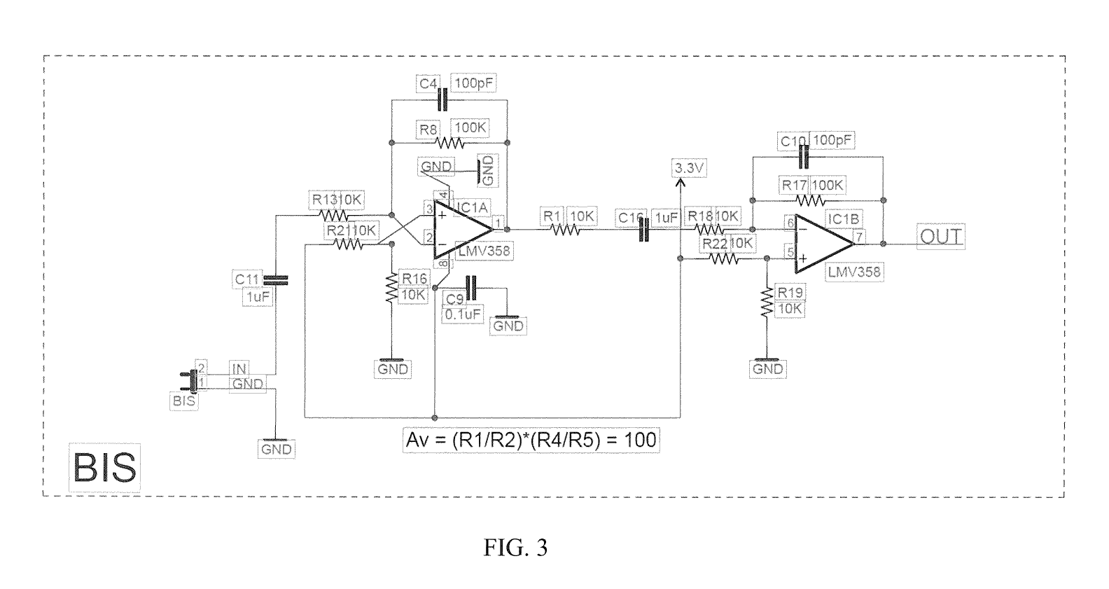

FIG. 4 shows the electrical connections of the IMU gyroscope 14 as it is used on the eSports fitness band 102 printed circuit board. It should be clearly understood that this is one example of the circuit design for the portion of the printed circuit board that encompasses the IMU gyroscope 14 and that substantial benefit may be derived from an alternative configuration.

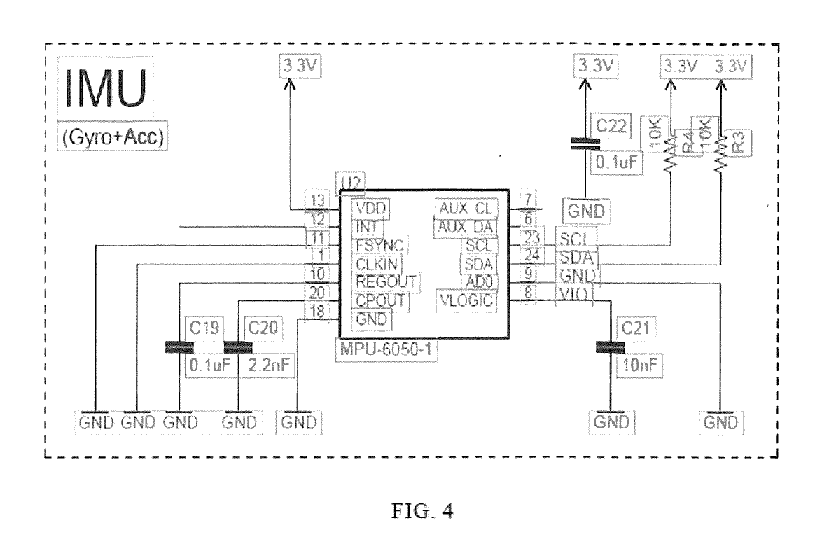

FIG. 5 shows an embodiment wherein the eSports fitness band 102 is used when the user is playing a video game 32. The video game 32 may be played on any type of videogame platform, such as a video game console (e.g. NINTENTO®, XBOX®, PLAY STATION®, etc.) or a personal computer (PC). The videogame platform will have wired or wireless communication system/protocol to allow the videogame platform to connect to the Internet. The figure shows a flow diagram that shows the data flow from all components in the system 100 and their respective interconnections. The entire data stream of the system 100 includes the separate flows of data captured by the eSports fitness band 102 and it's transmissions of that data to the user's mobile electronic device 18. As shown, the eSports fitness band 102 is used to gather the user's fitness data 34 from the incorporated electronic sensors (e.g IMU gyroscrope, heart rate sensor, etc.) and the user may input his nutritional data 36 into his mobile electronic device 18 via the system's 100 mobile software application and via the input keys or touchscreen of the mobile electronic device 18. The user's fitness data 34 and the user's nutritional data 36 are both then sent to the cloud repository 22 for storage wireless communication systems/protocols (e.g. WIFI®). The figure also shows the flow of video game 32 play data 38 from the video games 32 that the user plays to the cloud repository 22 for storage via wired or wireless communication systems/protocols (e.g. WIFI®) on the video gaming platform. Finally, the figure also shows the flow of the user's video game 32 play data 38, the user's physical fitness data 34, and the user's nutritional data 36—all of which are forwarded to the main data storage of the cloud repository 22 for transmission to either: 1) a user viewable website portal 23; or 2) to the user's desktop computer 24 where he may customize the appearance of the video game 32, fitness data 34, and nutritional data 36 and then use streaming media 27 to stream the customized video stream 26 on the Internet.

In an alternative embodiment, the eSports fitness band 102 may only be equipped with an IMU gyroscope 14 and/or an accelerometer 15 as its sensors. If the user wore the eSports fitness band 102 while playing a video game 32, the eSports fitness band 102 would receive motion sensor data 46 from these two sensors which may be used to provide information regarding the user's wrist movements and wrist activity during game play. The eSports fitness band 102 would gather and store motion sensor data 46 received from the IMU gyroscope 14 and/or an accelerometer 15 and send that information to the user's mobile electronic device 18 via its short range BLUETOOTH® wireless communication device/protocol 12. The user's mobile electronic device 18 would then send the motion sensor data 46 to the cloud data repository 22 for storage via wireless communication systems/protocols (e.g. WIFI®). The video game 32 play data 38 from the video games 32 that the user plays will also be send to the cloud repository 22 for storage via wired or wireless communication systems/protocols (e.g. WIFI®) on the video gaming platform. From the cloud repository 22, the user's video game 32 play data 38 and the user's motion sensor data 46 may be transmitted to either: 1) a user viewable website portal 23; or 2) to the user's desktop computer 24 where he may customize the appearance of the video game 32 and motion sensor data 46 and then use streaming media 27 to stream the customized video stream 26 on the Internet. For example, the customized overlay 30 may show the user's wrist movements, mouse clicks, etc. superimposed over the underlying video game 32. The user may also wish to include his nutritional data 36 and gym data 42 in the customized overlay 30 as discussed previously.

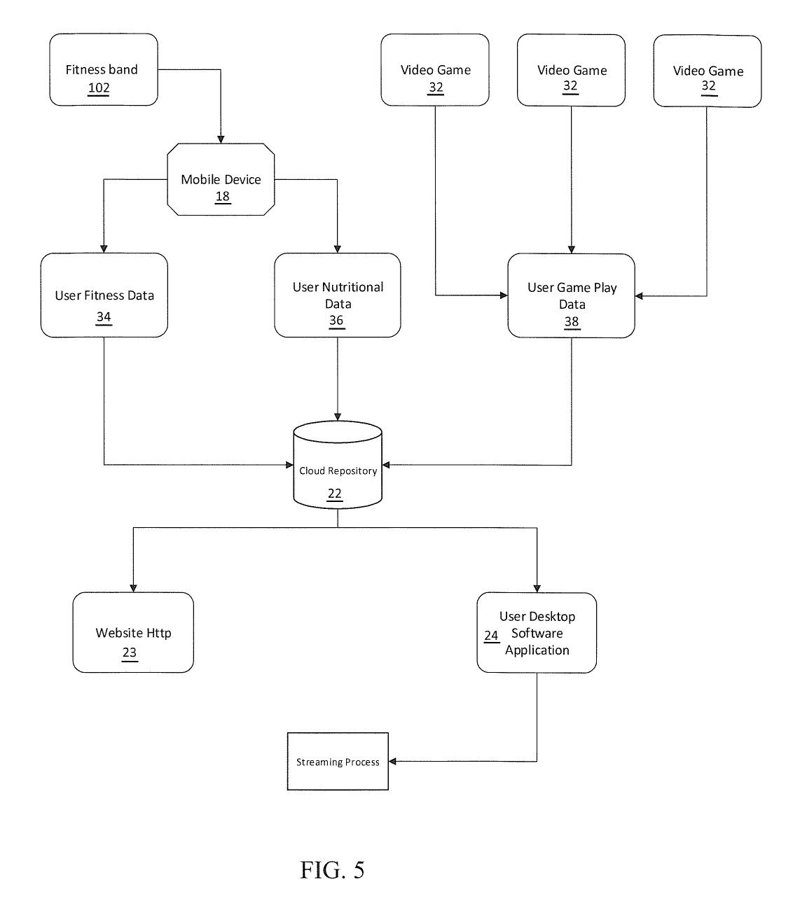

FIG. 6 shows an embodiment wherein the eSports fitness band 102 is being used when the user is in a gymnasium. The figure details the gymnasium sectors of the eSports fitness band 102 and its data flow scenario in gymnasium-related applications. In this embodiment, certain exercise devices may be able to communicate with the eSports fitness band 102. The exercise devices may include mechanical and electronic-based gymnasium equipment 40, free lift weight sets, and intelligent weight scales 44 that are equipped to send and receive data wirelessly (e.g. with BLUETOOTH®, WIFI®, or NFC wireless communication protocols). Where NFC is used, a NFC chip 13 may be embedded within the eSports fitness band 102. The eSports fitness band 102 will have an NFC chip 13 which communicates with an NFC reader or receiver that is contained in the gymnasium equipment 40 or smart weight scale 44. The exercise device (gymnasium equipment 40 and/or smart weight scale 44) may have a computer with a processor and memory which will allow it generate the user's gym data 42 by recording and storing certain information regarding its use by the user; e.g. length of time the equipment was being used, number of repetitions, distance run, amount of weight lifted, weight of the user, etc. The exercise device may record and transmit that user gym data 42 (e.g. length of time the equipment was being used, number of repetitions, distance run, amount of weight lifted, user's weight, etc.) to the cloud data repository 22. The gym equipment 40 and/or the smart weight scale 44 would be connected, either wired or wirelessly, to an onsite server located at the gymnasium (or other similar type of location) and the server would then transmit the gym data 42 to the cloud data repository 22. The eSports fitness band 102 would transmit the user's fitness data 34 and nutritional data 36 to the cloud data repository 22. The user can then access the compiled information via the system 100 website or through the user's mobile electronic device 18. The user may also manually enter gym data 42 that would otherwise be transmitted by the gym equipment 40 and/or the smart weight scale 44 into the eSports fitness band 102 if no such gym equipment 40 or smart weight scales 44 are available.

When calculating the user's calorie burn, the eSports fitness band 102 may measure user activity using a non-V02 max calculation based criteria such as heart rate, weight, age, exercise durations, and other criteria. These criteria's may be produced by the an IMU gyroscope 14, an NFC chip 13, and heart rate sensors 10 incorporated within the housing of the eSports fitness band 102. For example, where HR=heart rate; W=weight; A=age; and T=time;

Male: ((−55.0969+(0.6309×HR)+(0.1988×W)+(0.2017×A))/4.184)×60×T

Female: ((−20.4022+(0.4472×HR)−(0.1263×W)+(0.074×A))/4.184)×60×T

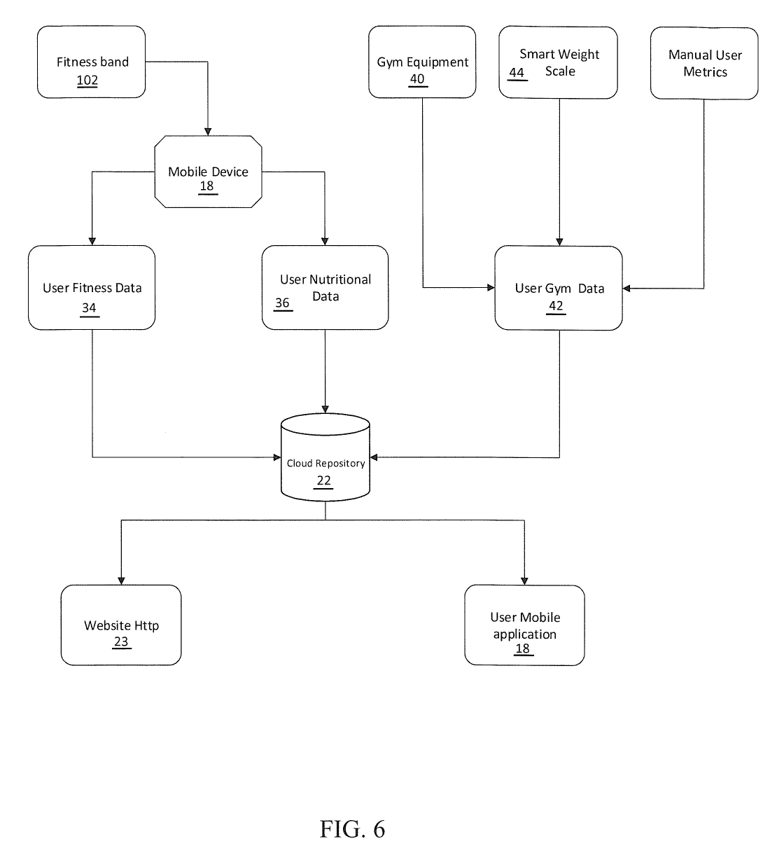

FIG. 7 shows how the eSports fitness band 102 may collect motion sensor data 46 from an IMU gyroscope 14 and/or accelerometer 15. The IMU gyroscope 14 and/or accelerometer may be used to capture the user's motion activity, calculate the user's steps, and to provide relevant data regarding the position of a user's hand movements in a three-axis scenario thus determining rotational values and speed of the user's wrist and arm motions while performing routines in the gymnasium or competing in variable sporting activities such as golf, video games 32, disc golf, basketball, football, baseball etc. The determination of the location of the wrist and arm and the associated movements is required in calculating velocity and angles of trajectory in these motions. The figure shows that motion sensor data 46 is being received by the eSports fitness band 102 from the IMU gyroscope 14 and/or accelerometer 15. Data regarding the user's state (e.g. whether the user is walking, sleeping, or exercising) is also determined. The user's state is calculated by a combination of values from the sensors that are measuring the user's heart rate, movement, and distance. These values are leveled through the calorie burn algorithm 48 to produce the user's calorie burn data; the calorie burn data is then sent to the cloud data repository 22 via the user's mobile electronic device 18. The user can then access the information via the system 100 website or through the user's mobile electronic device 18 via the system's 100 mobile software application.

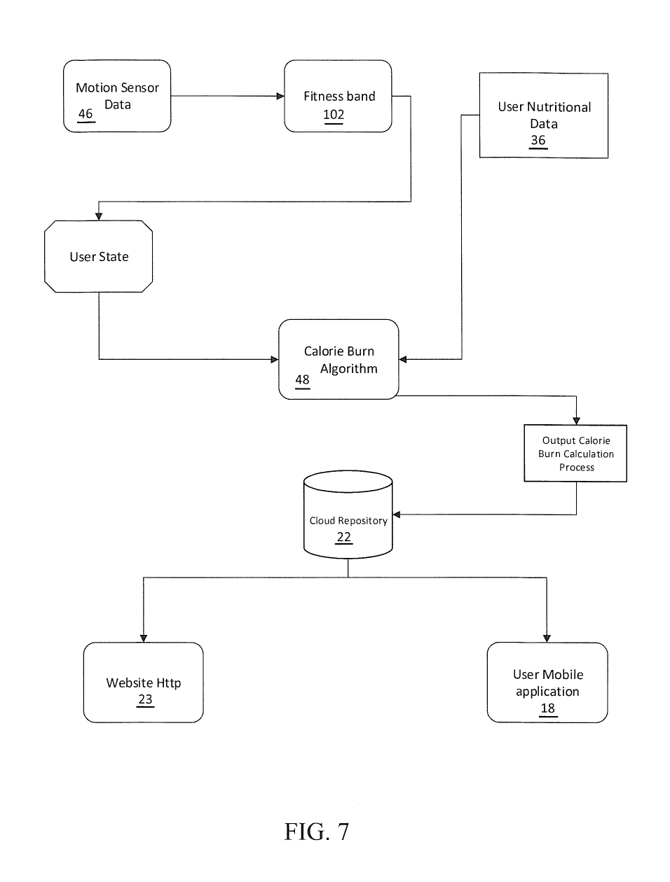

FIG. 8 shows the data flow and data points that are captured for determination of the caloric burn rates of the user during particular user states, such as walking, sleeping, and exercise. The figure also shows that the information regarding the user's state is used in combination with the motion sensor data 46 from the IMU gyroscope 14 to determine the user's calorie burn during that activity. The user's calorie burn is calculated with the calorie burn algorithm 48 and the calorie burn data is sent to the cloud data repository 22 via the user's mobile electronic device 18. The user can then access the information via the system 100 website or through the user's mobile electronic device 18 via the system's 100 mobile software application.

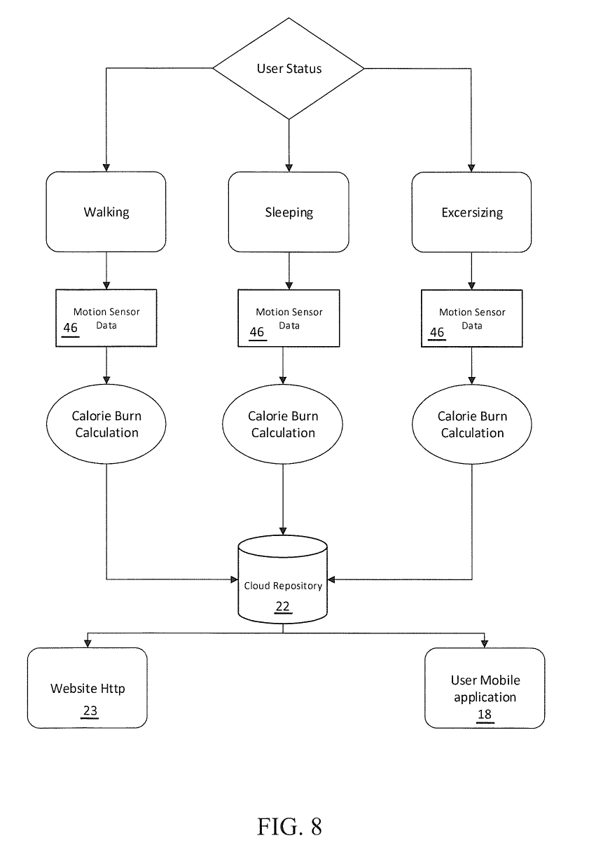

FIG. 9 shows the relationship and informational flow from the IMU gyroscope 14 and the optical heart rate sensor 10 that are equipped in the eSports fitness band 102. Where the heart rate sensor 10 detects that the user's heart rate is elevated, that heart rate data can be viewed in conjunction with motion sensor data 46 from the IMU gyroscope 14 to determine whether the user is running or performing some other type of exercise. Similarly, where the heart rate sensor 10 detects that the user's heart rate is not elevated, the heart rate data can be viewed in conjunction with the motion sensor data 46 from the IMU gyroscope 14 to determine whether the user is sleeping, sitting, or walking. The user's calorie burn may then be calculated according to the user's heart rate.

The eSports fitness band 102 may be used for hydration monitoring. This may be a manual data-point input wherein the user uses an action key 50 on the eSports fitness band 102 to insert predetermined selections in mL in order to track and record the totals of the user's water consumption during a current 24-hour period. The eSports fitness band 102 may also record multiple day average water consumption for the user. The software of the eSports fitness band 102 then uses algorithms to determine—by a calculation of body mass index, age, weight, calorie burn, local weather conditions, and other criteria averages—the actual water consumption by the user and an estimated total suggested consumption of water for the user. The results are then displayed on the users' mobile electronic device 18 application. The reminder settings on the user's mobile electronic device 18 application can be applied to access the alarm protocols and send a signal to the vibration motor of the mobile electronic device 18 in order to advise the user that additional water is required by the user based on the calculated metrics.

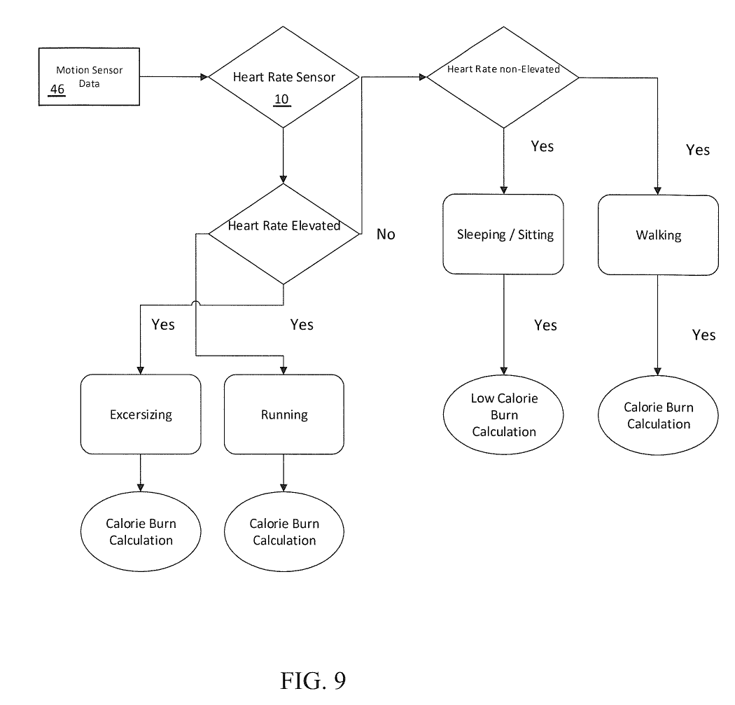

FIG. 10 shows an embodiment wherein the eSports fitness band 102 has an input mechanism such as an action key 50 that the user may press to input data regarding his liquid ingestions. This preferably would be used primarily for only water ingestion, but may be used for any type of liquid the user deems appropriate. The action key 50 is meant to be a physical mechanical shortcut on the eSports fitness band 102 that provides a convenient manner of registering the user's water intake when the user's mobile electronic device 18 is not accessible. The user's water intake data may be stored on the eSports fitness band's 102 on board memory 03.

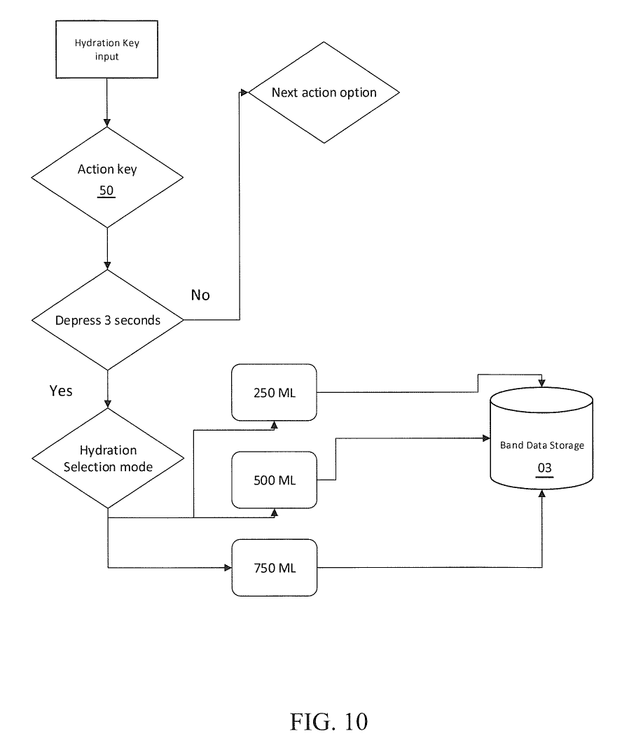

FIG. 11 is an exemplary screenshot showing the carousel selection feature of the system 100. The carousel will display a picture of the video game 32 cover art for each video game 32 that the user has registered with the system 100. The following video games 32 are shown as examples only and it should be clearly understood that any video game 32 may be used: LEAGUE OF LEGENDS®, DOTA 2®, COUNTER-STRIKE: GLOBAL OFFENSIVE®, BATTLEFIELD 4® and WORLD OF TANKS®. In order to register a video game 32 with the system 100, the user will first select the preferred video game 32 title from an updated list of video game 32 titles. If the video game 32 desired is not available, the user may manually enter it into the system 100. The user will then enter the user's in-game username and password and select the “verify” option in the system 100. The system 100 will automatically verify the user's account with the chosen video game 32 title and register that video game 32 title in the approved system 100 listing and add the gaming image tile to the carousel selection module. The carousel will allow the user to choose one of the pertinent video game 32 titles shown. Once selected, the system 100 will then track the required video game 32 metrics of the selected video game 32, as shown in FIG. 5. A plurality of video game 32 titles can be chosen and personal profiles for each video game 32 can be created on the user's account.

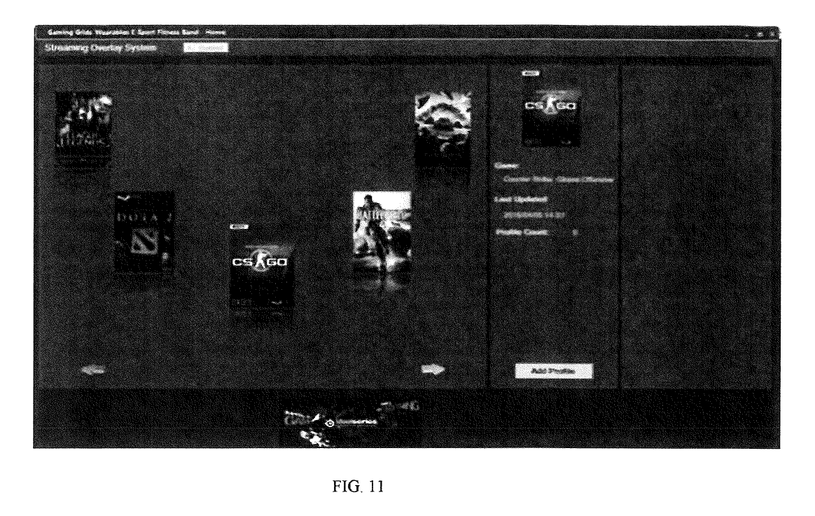

FIG. 12 shows a screen shot of the customizable overlay 30 of the present invention. The overlay 30 is positioned over images of the video game 32 so that the viewers may watch the images of the video game 32 as the user is playing the video game 32 and also view the user's fitness data 34 and nutritional data 36 at the same time. The customizable overlay 30 allows the user to change to viewable environment that the user desires to produce for viewers of the customized video stream 26. For example, the user may select the background color, background opacity, a file to upload into the background, header text color, header text opacity, data text color, data text opacity. The user may also customize the alignment of the text of the overlay 30 by adjusting their position, height, and width. The user may also select which objects (i.e. fitness data 34, nutritional data 36, etc.) to display in the overlay 30. Here, the user has selected to display his heart rate (in beats/minute), his step count, the distance he had run/walked, the user's calorie burn, the user's calorie consumption, the user's activity tracking, and his hydration tracking. It should be clearly understood that other fitness data 34 and/or nutritional data 36 may be selected by the user to be shown in the overlay 30.

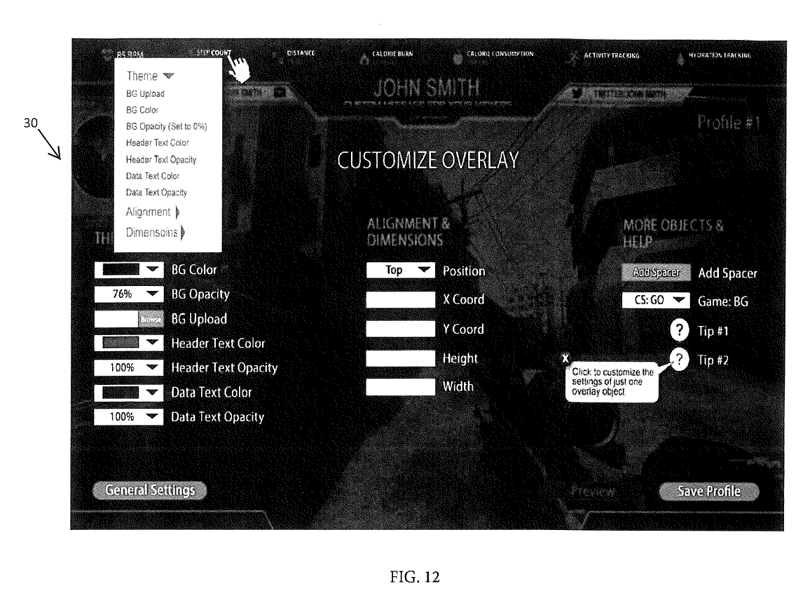

FIG. 13 shows a screen shot of the creation of the physical metrics streaming feature of the present invention wherein the user may choose which of his physical metrics (e.g. heart rate, calorie burn, etc.) will be shown to the viewers of the customized video stream 26. The user may create and store multiple profiles with the system's 100 software application that resides on the user's desktop/laptop computer 24. So if the user wishes to have several overlay 30 options in different configurations of where the information is displayed, they may do that here. For example, the user may set up one overlay 30 that displays the user's heart rate, step count, distance walked, calorie burn, calorie consumption, activity tracking, and hydration tracking at the top of the screen and then set up another overlay 30 that shows only the user's heart rate, calorie burn, and calorie consumption on the left side of the screen. Once that profile is defined by what and where the metric viewing items are placed and the overlay configuration is decided upon by the user, then that particular view is saved.

The user may choose to display all of the user's captured physical and nutritional data 36 metrics along with the user's competitive video game 32 ranking in the system 100, as well as the system's 100 automatically generated suggestions for increased proficiency based on user data. As an example, based upon the user's fitness data 34, the user's nutritional data 36, and the user's video game 32 play data 38, the system 100 may generate a suggestion to the user that the user needs to consume more water, lose weight, or exercise more if the user wishes to improve their performance in playing the video game 32.

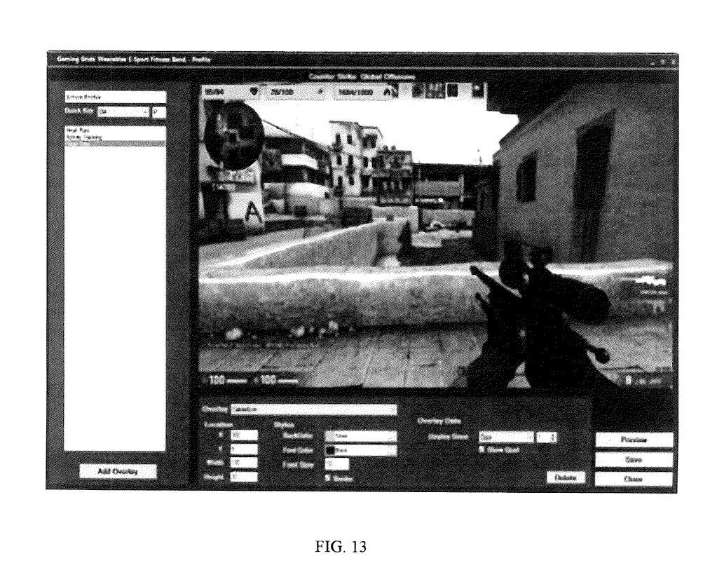

FIG. 14 is a screen shot of the “preview” feature of the overlay 30. When the user wishes to “preview” the overlay 30, the user is shown the overlay 30 placed on top of the underlying video game 32, as it would appear to the viewers watching the customized video stream 26. In this example, the user has selected to show his heart rate, step count, distance, calorie burn, calorie consumption, activity tracking, and hydration tracking in the overlay 30 of the customized video steam 26.

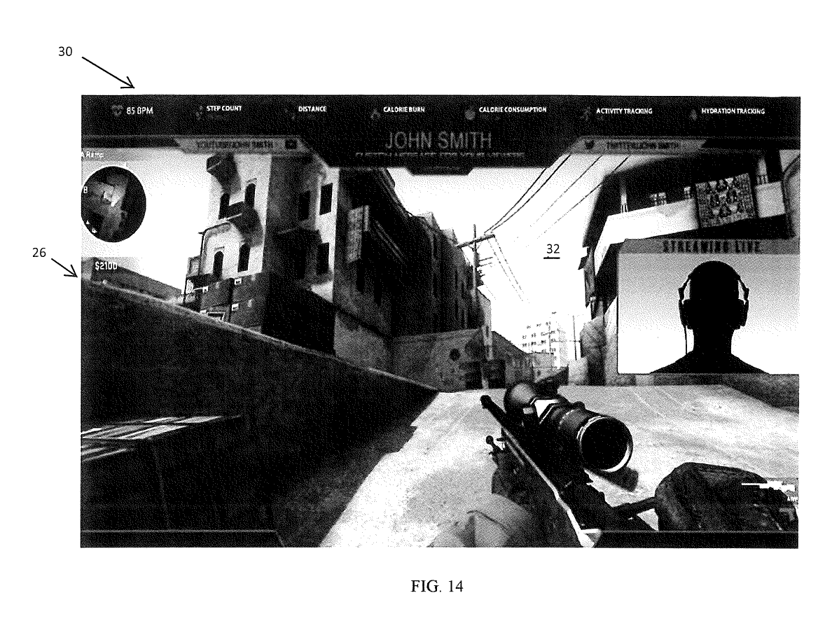

FIG. 15 is a screen shot of the customized video stream 26 that contains all of the features and customizations that have been selected by the user to be shown in the overlay 30. In this example, HITBOX® streaming media 27 is being used to stream the customized video stream 26, but it should be clearly understood that any other suitable streaming media 27 may be used. As discussed above, the customized video stream 26 displays the underlying video game 32 that the user is playing with the customized overlay 30 on top. In the overlay 30, the user has chosen to display his heart rate, step count, distance, calorie burn, calorie consumption, activity tracking, and hydration tracking.

FIG. 16 shows an embodiment wherein the eSports fitness band 102 is being used when the user is in a gymnasium that uses only NFC embedded gymnasium equipment 40. The figure shows all connectivity that would be used within the gym environment. In this example, the gymnasium may have life cycles, free weights, smart weight scales 44 and other exercise machines/equipment 40 that are fitted with wireless communication devices, such as BLUETOOTH® or NFC chips. As shown in the figure, information such as the user's identification, age, sex, etc., may be transmitted from the user's eSports fitness band 102 to the exercise machines/equipment 40 and information from the exercise machines/equipment 40 and smart weight scales 44 may be transmitted to the user's eSports fitness band 102 via the wireless communication devices contained within the eSports fitness band 102, the exercise machines/equipment 40 and smart weight scales 44. Also shown is the gathering of the user's fitness data 34, the user's nutritional data 36, and gym data 42 from the exercise equipment and the transmission of all of that data to the cloud data repository 22 via the user's mobile electronic device 18. The user can then access the information via the system 100 website or through the user's mobile electronic device 18 via the system's 100 mobile software application.

FIG. 17 shows an exemplary player leveling scenario. The in-game actions that a user performs when playing a video game 32 all contribute to the user's video game 32 play data 38. Specifically, the user's video game 32 play data 38 may contain information regarding the user's kills, deaths, awards, accuracy, weapons used, movements/clicks, completion timing, reaction time, keyboard movement, time online, user system parameters, and other in-game events. These data points are then used to provide the user with benchmarks of performance against other users (e.g. the user may need to accomplish more kills in a shorter completion time than another player) and additional performance benchmark targets for the user to attain (e.g. the user may be informed that another player achieved more kills in a shorter completion time and that that other player performs more daily exercise than the user), which will assist the user in attaining greater performance through physical activity to achieve better performance in the activities of video game play. Essentially, the benchmarking algorithms of the system 100 takes the user's fitness data 34, nutritional data 36, and video game 32 play data 38 and compares it to that of another player/user. The result is that the user may be informed about the other player's/user's in-game performance as well as the other player's/user's fitness data 34 and nutritional data 36, which would ideally inspire the user to increase his own physical fitness and to improve his nutrition in order to improve his performance in the eSports events.

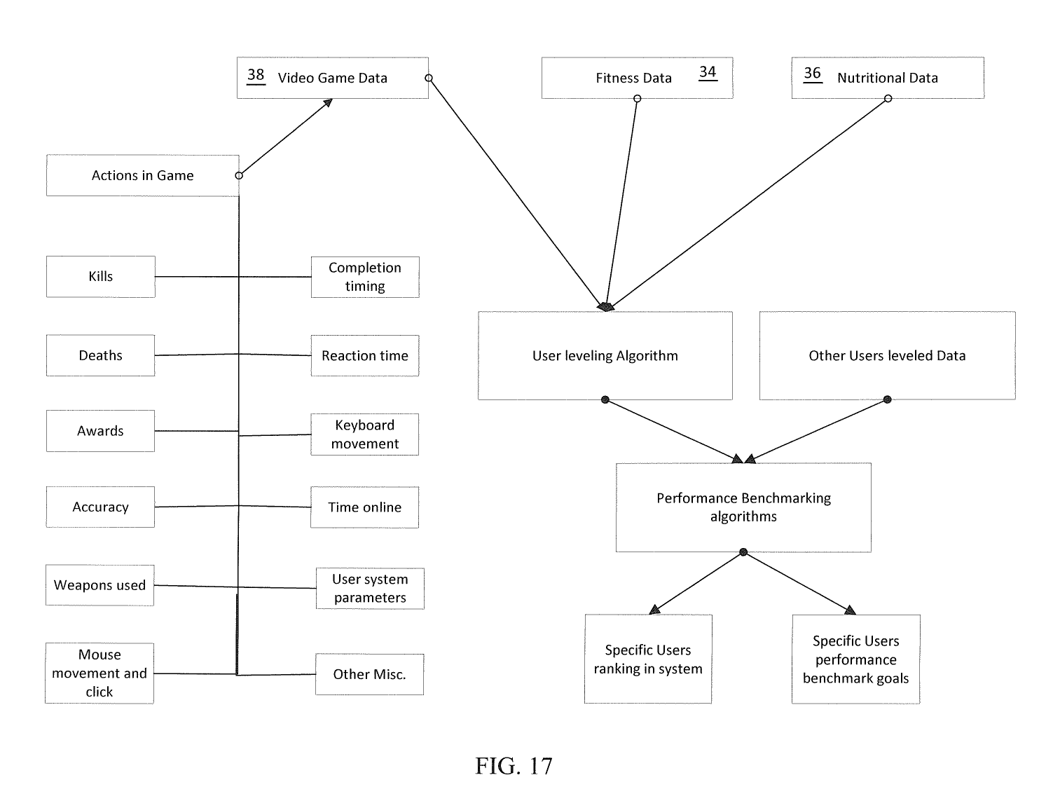

FIG. 18 shows an exemplary set of screen shots from the user's mobile electronic device 18. From his mobile electronic device 18, the user may view his fitness data 34, his nutritional data 36, and his video game 32 play data 38 via the system's 100 mobile software application. By cross referencing all of this data, the user may note that he performed better when playing a particular game on days when he had consumed at least 0.5 gal of water, consumed at least 2,000 calories from food, and had walked at least 8,000 steps.

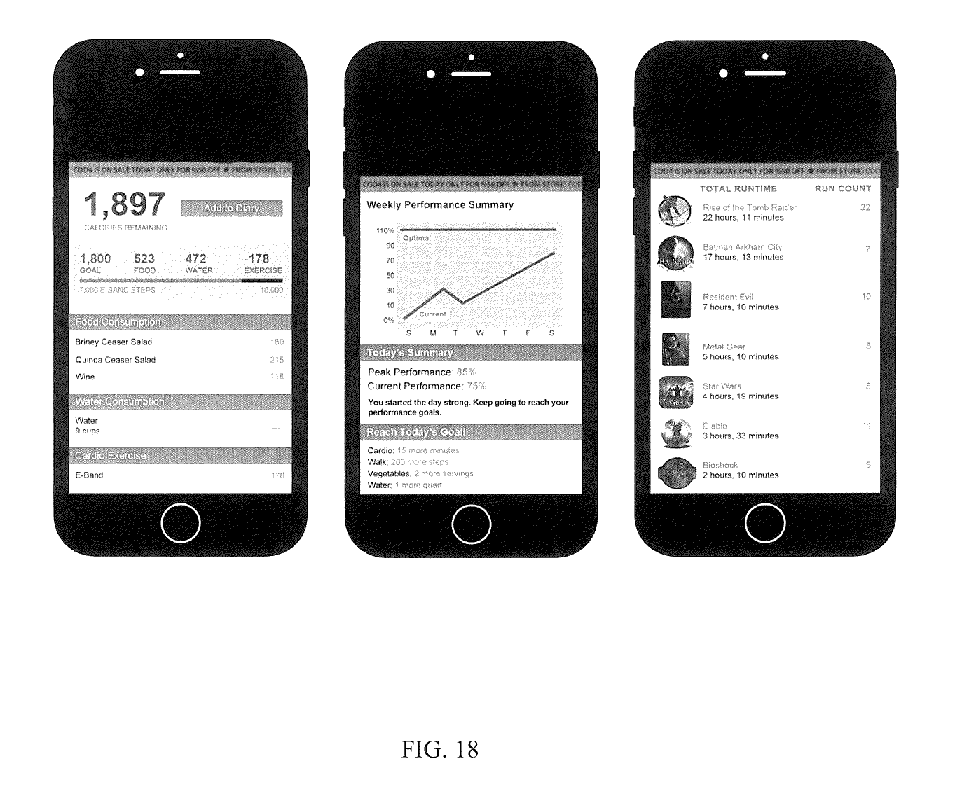

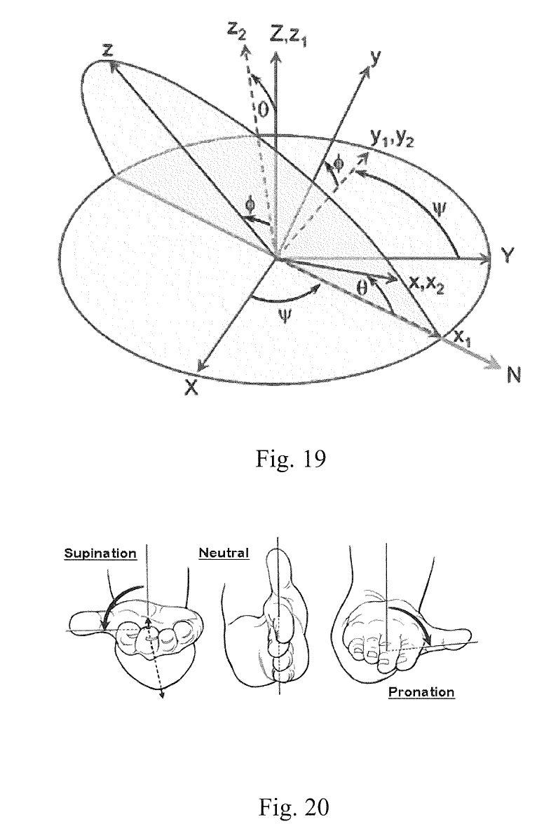

In relation to disc golf, basketball, football and other outdoor related sports that would constitute additional exercise and activity-related data that would be incorporated in the required physical fitness metric datasets, such data would be retrieved from the eSports band's 102 sensor array of the 3D-Gyroscope 14 and 3D-Accelerometer 15 components. As shown in FIGS. 19-20, the data points referenced would be the user's wrist position, rotation, and orientation in the X, Y and Z axes. The pitch, roll, and yawl are the typical primary 3-axes and the rotation acceleration for each axis comprises the second 3-axes.

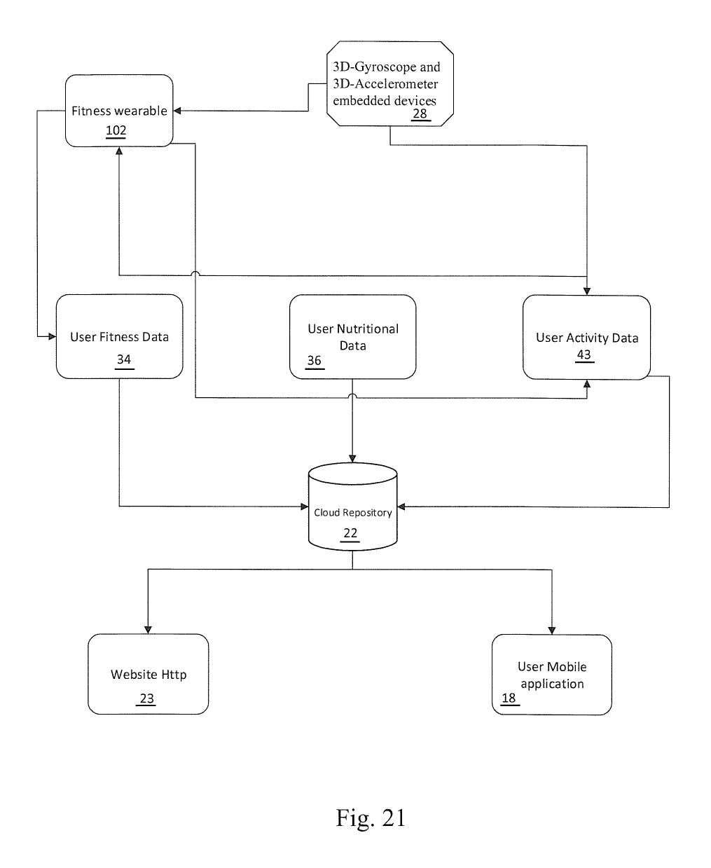

Referring to FIG. 21, additional relative data would be provided in this scenario by emplacement of a cellular or BLUETOOTH® wireless communication electronics package that includes a sensor array of a GPS Tracking module, 3D-Gyroscope and 3D-Accelerometer components on a remote device 28. The remote device 28 would have a processor and a memory therein. These remote mounted components (i.e. the GPS Tracking module, 3D-Gyroscope and 3D-Accelerometer) on the remote devices 28 such as discs would store the user's activity data 43 (e.g. distance the disc was thrown, speed of the disc, etc.) upon integrated memory modules within the remote devices 28, then transmit the stored directional and velocimetry data to the user's mobile device 18 via the cellular or BLUETOOTH® wireless communication technology/protocols. The process for data retrieval would constitute activating an option in the user's mobile software application to retrieve the data store from the onboard memory of the remote device 28 once the remote device 28 is within proximity to connect with the user's mobile device 18 via its cellular or BLUETOOTH® wireless communication device/protocols 12. The data once retrieved by the user's electronic mobile device 18 would be transmitted to and stored on the cloud data repository 22 for processing and return display on the user's web portal 23 and/or through the user's mobile electronic device 18 via the system's 100 mobile software application.

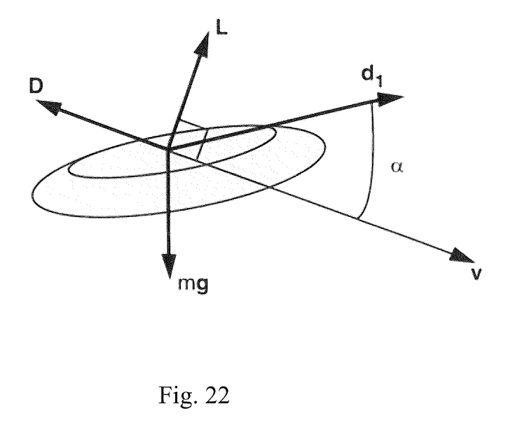

Referring to FIG. 22, the displayed compiled data set would provide the user with velocimetry, angular information and its relation to the user's wrist position as provided by the eSports fitness band 102 electronic sensor array. The software algorithms would also provide the user with tooltips on how to change the angular ratios of the disc or other remote device 28 by adjusting wrist position and velocity of the user's wrist motions while performing this activity.

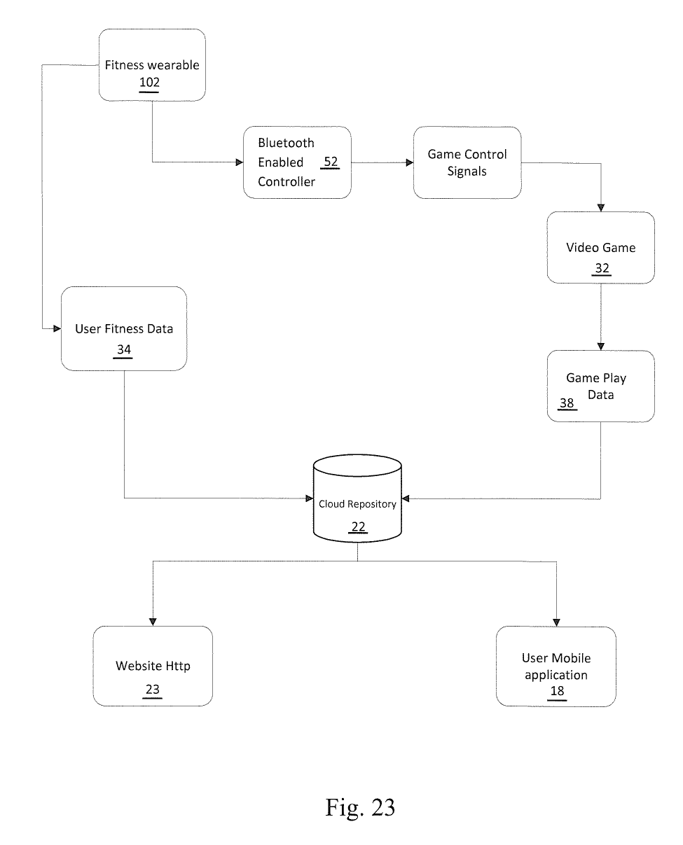

Referring to FIG. 23, the eSports fitness band 102 also has the capability to relay gesture commands to an ancillary BLUETOOTH® wireless communication enabled game controller 52 though its BLUETOOTH® wireless communication device/protocol 12. The gesture commands would be derived via information provided by the gyroscopic and velocimetry data of the 3D Gyroscope 14 and the 3D accelerometer 15 incorporated in the electronics package of the eSports fitness band 102. The BLUETOOTH® wireless communication enabled receiver/game controller 52 would translate the user's hand and wrist movements along with the user's relative position and through proprietary algorithms interpret the signals in real time as to provide synchronous activity on the BLUETOOTH® receiver/game controller 52. These actions would then be translated to simulate mouse movement and game pad inputs. The user fitness data 34 may be sent to the cloud data repository 22 via the user's electronic mobile device 18 and the video game 32 play data 38 from the video games 32 that the user plays may be sent to the cloud repository 22 for storage via wired or wireless communication systems/protocols (e.g. WIFI®) on the video gaming platform. Once the user's fitness data 34 and video game 32 play data 38 have been sent to the cloud data repository 22, it will be processed and returned for display on the user's web portal 23 and/or through the user's mobile electronic device 18 via the system's 100 mobile software application.

The user may also assign a “hotkey” shortcut value to the shortcuts so that while the user is playing and streaming he may change the output view of the profile on the fly during the users broadcast. For example, if the user is wearing the eSports fitness band 102 while playing a video game 32, the user may program a certain movement of his wrist/arm (e.g. rotating his wrist in a counterclockwise circle) to activate a hotkey that causes the video game 32 to switch between different fields of view (e.g. switching between first person and third-person views). Other examples of hotkeys would be that a certain hand movement initiates the play of a video clip, or displays a picture or emoji, or displays certain predetermined words in the chat section of the customized video stream 26. The gyroscope 14 and/or accelerometer 15 will sense the movement of the user's wrist/arm and if the motion sensor data 46 indicates that the user rotated his wrist in a counterclockwise circle, the BLUETOOTH® wireless communication enabled receiver/controller 52 would translate the user's hand and wrist movements and through proprietary algorithms interpret the signals in real time as to provide synchronous activity on the BLUETOOTH® receiver/controller 52. These actions would then be translated to simulate the activation of the hotkey. In this example, the field of view would be changed.

The foregoing description is illustrative of particular embodiments of the application, but is not meant to be limitation upon the practice thereof. While the invention has been illustrated with respect to several specific embodiments thereof, these embodiments should be considered as illustrative rather than limiting. Various modifications and additions may be made and will be apparent to those skilled in the art. Accordingly, the invention should not be limited by the foregoing description, but rather should be defined only by the following claims.

What is claimed is:

1. An eSports fitness and training system comprising:
a cloud data repository;
a wearable activity tracking device having:
a plurality of sensors contained therein, wherein the plurality of sensors generate physical fitness data of a user;
a processor;
a memory for storing the physical fitness data of the user; and
a short range wireless communication device for transmitting the physical fitness data of the user according to a Bluetooth wireless protocol;
a near field communication (NFC) chip for transmitting the physical fitness data of the user according to a NFC wireless protocol;
a video game platform that generates user game play data as the user plays a video game on the video game platform and that transmits the user game play data to the cloud data repository;
an exercise device that generates user gym data as the user exercises on the exercise device and that transmits the user gym data to the cloud data repository, wherein the exercise device has an NFC reader to receive the physical fitness data of the user according to the NFC wireless protocol; and
a mobile electronic device having:
a processor for executing a mobile software application that allows the user to input nutritional data;
a memory for storing the mobile software application; and
a short range wireless communication device to communicate with the short range wireless communication device of the wearable activity tracking device to receive the physical fitness data of the user according to the Bluetooth wireless protocol; and
a wireless communication device to transmit the physical fitness data and the nutritional data to the cloud data repository;
wherein the physical fitness data, the nutritional data, and the game play data are transmitted from the cloud data repository to a computer for use in a customized video stream, wherein the customized video stream comprises an overlay that is superimposed over underlying images of the video game that the user is playing, and wherein the overlay contains at least one of the physical fitness data of the user and the nutritional data of the user.

2. The eSports fitness and training system of claim 1 wherein the plurality of sensors includes at least two of an internal measurement unit (IMU) gyroscope, an accelerometer, a heart rate sensor, and a bioimpedance sensor.

3. An eSports fitness and training system comprising:
a cloud data repository;
a wearable activity tracking device having:
at least one of an internal measurement unit (IMU) gyroscope and an accelerometer, wherein the at least one of the IMU gyroscope and an accelerometer generates motion sensor data of a user;
a processor;
a memory for storing the motion sensor data of the user; and
a short range wireless communication device for transmitting the motion sensor data of the user according to a Bluetooth wireless protocol;
a near field communication (NFC) chip for transmitting the motion sensor data of the user according to a NFC wireless protocol;
a video game platform that generates user game play data as the user plays a video game on the video game platform and that transmits the user game play data to the cloud data repository; and
a mobile electronic device having:
a processor for executing a mobile software application;
a memory for storing the mobile software application; and
a short range wireless communication device to communicate with the short range wireless communication device of the wearable activity tracking device to receive the motion sensor data of the user according to the Bluetooth wireless protocol; and
at least one of a wired communication device and a wireless communication device to transmit the motion sensor data to the cloud data repository.

4. The eSports fitness and training system of claim 3 wherein the mobile electronic device further comprises at least one of input keys and a touchscreen for the user to input nutritional data into the mobile electronic device, wherein the nutritional data is transmitted from the mobile electronic device to the cloud data repository through the at least one of the wired communication device and the wireless communication device of the mobile electronic device.

5. The eSports fitness and training system of claim 4 wherein the game play data and the nutritional data are transmitted from the cloud data repository to one of a user viewable website portal and a computer for use in a customized video stream.

6. The eSports fitness and training system of claim 5 wherein the customized video stream comprises an overlay that is superimposed over underlying images of the video game that the user is playing, wherein the overlay contains the nutritional data of the user.

7. The eSports fitness and training system of claim 3 wherein the game play data and the motion sensor data are transmitted from the cloud data repository to one of a user viewable website portal and a computer for use in a customized video stream.

8. The eSports fitness and training system of claim 7 wherein the customized video stream comprises an overlay that is superimposed over underlying images of the video game that the user is playing, wherein the overlay contains the motion sensor data of the user.

9. The eSports fitness and training system of claim 3 further comprising a remote device that generates activity data when the remote device is thrown a distance by the user, wherein the remote device comprises:
a plurality of sensors contained therein, wherein the plurality of sensors comprise a global positioning system (GPS) tracking module, a gyroscope, and an accelerometer; and
a short range wireless communication device to communicate with the short range wireless communication device of the mobile electronic device to transmit the activity data to the mobile electronic device, wherein the activity data is then transmitted from the mobile electronic device to the cloud data repository via the at least one of the wired communication device and the wireless communication device of the mobile electronic device.

10. An eSports fitness and training system comprising:
a cloud data repository;
a wearable activity tracking device having:
at least one sensor contained therein, wherein the at least one sensor generates at least one of physical fitness data and motion sensor data of a user;
a processor;
a memory for storing the at least one of the physical fitness data and the motion sensor data of the user; and
a short range wireless communication device;
a video game platform that generates user game play data as the user plays a video game on the video game platform and that transmits the user game play data to the cloud data repository; and
a mobile electronic device having:
a processor for executing a mobile software application that allows the user to view the at least one of the physical fitness data and the motion sensor data of the user;
a memory for storing the mobile software application;
a short range wireless communication device to communicate with the short range wireless communication device of the wearable activity tracking device to receive the at least one of the physical fitness data and the motion sensor data of the user; and
at least one of a wired communication device and a wireless communication device to transmit the at least one of the physical fitness data and the motion sensor data to the cloud data repository.

11. The eSports fitness and training system of claim 10 wherein the game play data and the at least one of the physical fitness data and the motion sensor data are transmitted from the cloud data repository to a user viewable website portal.

12. The eSports fitness and training system of claim 10 wherein the game play data and the at least one of the physical fitness data and the motion sensor data are transmitted from the cloud data repository to a computer for use in a customized video stream.

13. The eSports fitness and training system of claim 12 wherein the customized video stream comprises an overlay that is superimposed over underlying images of the video game that the user is playing, wherein the overlay contains the at least one of the physical fitness data and the motion sensor data of the user.

14. The eSports fitness and training system of claim 10 wherein the short range wireless communication device of the mobile electronic device communicates with the short range wireless communication device of the wearable activity tracking device via a Bluetooth wireless protocol.

15. The eSports fitness and training system of claim 10 further comprising an exercise device that generates user gym data as the user exercises on the exercise device and that transmits the user gym data to the cloud data repository.

16. The eSports fitness and training system of claim 15 wherein the wearable activity tracking device has a near field communication (NFC) chip and wherein the exercise device has a NFC reader to communicate with the NFC chip within the wearable activity tracking device through a NFC wireless protocol to receive the at least one of the physical fitness data and the motion sensor data of the user.

17. The eSports fitness and training system of claim 10 wherein the mobile electronic device further comprises at least one of input keys and a touchscreen for the user to input nutritional data into the mobile electronic device, wherein the nutritional data is transmitted from the mobile electronic device to the cloud data repository through the at least one of the wired communication device and the wireless communication device of the mobile electronic device.

18. The eSports fitness and training system of claim 17 wherein the nutritional data is transmitted from the cloud data repository to a user viewable website portal.

19. The eSports fitness and training system of claim 17 wherein the nutritional data is transmitted from the cloud data repository to a computer for use in a customized video stream.

20. The eSports fitness and training system of claim 19 wherein the customized video stream comprises an overlay that is superimposed over underlying images of the video game that the user is playing, wherein the overlay contains the nutritional data of the user.

21. The eSports fitness and training system of claim 10 wherein the at least one sensor is at least one of an internal measurement unit (IMU) gyroscope, an accelerometer, a heart rate sensor, and a bioimpedance sensor.

22. The eSports fitness and training system of claim 10 wherein the at least one sensor is at least one of an internal measurement unit (IMU) gyroscope and an accelerometer, wherein the wearable activity tracking device receives the motion sensor data from the at least one of the IMU gyroscope and the accelerometer.

23. The eSports fitness and training system of claim 22 wherein the motion sensor data is used to track wrist movements of the user while the user is playing the video game.

24. The eSports fitness and training system of claim 23 further comprising a video game controller that has a short range wireless communication device that communicates with the short range wireless communication device of the wearable activity tracking device in order to receive the motion sensor data and translate the wrist movements of the user into one of mouse movements and game pad inputs.

25. The eSports fitness and training system of claim 10 further comprising a seat location at a local area network (LAN) gaming center that generates user location data when the user is positioned at the seat location and that transmits the user location data to at least one computer that is hosting a gaming event within the LAN gaming center.

26. The eSports fitness and training system of claim 25 wherein the wearable activity tracking device has a NFC chip and wherein the seat location has a NFC reader to communicate with the NFC chip within the wearable activity tracking device through a NFC wireless protocol to receive the user location data.

27. The eSports fitness and training system of claim 10 further comprising a remote device that generates activity data when the remote device is thrown a distance by the user, wherein the remote device comprises:
a plurality of sensors contained therein, wherein the plurality of sensors comprise a global positioning system (GPS) tracking module, a gyroscope, and an accelerometer; and
a short range wireless communication device to communicate with the short range wireless communication device of the mobile electronic device to transmit the activity data to the mobile electronic device, wherein the activity data is then transmitted from the mobile electronic device to the cloud data repository via the at least one of the wired communication device and the wireless communication device of the mobile electronic device.

28. A method for tracking eSports fitness data comprising the steps of:
receiving physical fitness data of a user, by a wearable activity tracking device that is worn by the user, wherein the wearable activity tracking device receives the physical fitness data from a plurality of sensors contained therein;
transmitting the physical fitness data from the wearable activity tracking device through a short range wireless communication device of the wearable activity tracking device according to a Bluetooth wireless protocol;
receiving the physical fitness data, by a mobile electronic device through a short range wireless communication device according to the Bluetooth wireless protocol;
receiving nutritional data, by the mobile electronic device, wherein the nutritional data is input by the user through one of input keys and a touchscreen of the mobile electronic device;
transmitting the physical fitness data and the nutritional data from the mobile electronic device to a cloud data repository via a wireless communication device;
receiving by the cloud data repository, the physical fitness data and the nutritional data;
receiving by the cloud data repository, game play data from a video game platform on which the user is playing a video game;
transmitting the physical fitness data, the nutritional data, and the game play data by the cloud data repository to a computer;
creating a customized video stream on the computer wherein the customized video stream comprises an overlay that is superimposed over underlying images of the video game that the user is playing, and wherein the overlay contains at least one of the physical fitness data of the user and the nutritional data of the user; and
streaming the customized video stream on the Internet.

29. The method of claim 28 wherein the wearable activity tracking device receives physical fitness data from at least two of an internal measurement unit (IMU) gyroscope, an accelerometer, a heart rate sensor, and a bioimpedance sensor.

30. The method of claim 28 further comprising the step of receiving by the cloud data repository, gym data from an exercise device on which the user is exercising.

31. The eSports fitness system of claim 30 wherein the wearable activity tracking device has a near field communication (NFC) chip and wherein the exercise device has a NFC reader to communicate with the NFC chip within the wearable activity tracking device through a NFC wireless protocol to receive the physical fitness data of the user.

32. The method of claim 28 further comprising the step of transmitting the physical fitness data, the nutritional data, and the game play data by the cloud data repository to a user viewable website portal.

33. A method for tracking eSports data of a user comprising the steps of:
receiving at least one of physical fitness data and motion sensor data of the user, by a wearable activity tracking device that is worn by the user, wherein the wearable activity tracking device receives the at least one of the physical fitness data and the motion sensor data from at least one sensor contained therein;
transmitting the at least one of the physical fitness data and the motion sensor data from the wearable activity tracking device through a short range wireless communication device of the wearable activity tracking device;
receiving the at least one of the physical fitness data and the motion sensor data, by a mobile electronic device through a short range wireless communication device that communicates with the short range wireless communication device of the wearable activity tracking device;
receiving nutritional data by the mobile electronic device, wherein the nutritional data is input by the user through one of input keys and a touchscreen of the mobile electronic device;
transmitting the at least one of the physical fitness data and the motion sensor data from the mobile electronic device to a cloud data repository via at least one of a wired communication device and a wireless communication device;
transmitting the nutritional data from the mobile electronic device to the cloud data repository via the at least one of the wired communication device and the wireless communication device;
receiving by the cloud data repository, the at least one of the physical fitness data and the motion sensor data;
receiving by the cloud data repository, the nutritional data;
receiving by the cloud data repository, game play data from a video game platform on which the user is playing a video game; and
transmitting the nutritional data, the game play data, and the at least one of the physical fitness data and the motion sensor data by the cloud data repository to at least one of a user viewable website portal and a computer for creating a customized video stream that is streamed on the Internet.

34. The method of claim 33 wherein the step of creating the customized video stream further comprises the step of creating an overlay that is superimposed over underlying images of the video game that the user is playing, wherein the overlay contains at least one of the nutritional data of the user, the physical fitness data of the user, and the motion sensor data of the user.

35. The method of claim 33 wherein the at least one sensor within the wearable activity tracking device is at least one of an internal measurement unit (IMU) gyroscope, an accelerometer, a heart rate sensor, and a bioimpedance sensor.

36. The method of claim 33 wherein the short range wireless communication device of the mobile electronic device communicates with the short range wireless communication device of the wearable activity tracking device via a Bluetooth wireless protocol.

37. The method of claim 33 further comprising the steps of:
generating user gym data by an exercise device as the user exercises on the exercise device; and
transmitting by the exercise device, the user gym data to the cloud data repository.

38. The method of claim 37 wherein the wearable activity tracking device has a near filed communication (NFC) chip and wherein the exercise device has a NFC reader to communicate with the NFC chip within the wearable activity tracking device through a NFC wireless protocol to receive the physical fitness data of the user.

39. The method of claim 33 wherein the at least one sensor within the wearable activity tracking device is at least one of an internal measurement unit (IMU) gyroscope and an accelerometer, wherein the wearable activity tracking device receives the motion sensor data from the at least one of the IMU gyroscope and the accelerometer.

40. The method of claim 39 wherein the motion sensor data is used to track wrist movement of the user while the user is playing the video game.

41. The method of claim 40 further comprising the steps of:
transmitting the motion sensor data from the wearable activity tracking device through the short range wireless communication device of the wearable activity tracking device;
receiving by a video game controller, the motion sensor data through a short range wireless communication device that communicates with the short range wireless communication device of the wearable activity tracking device; and
translating the wrist movements of the user into one of mouse movements and game pad inputs.

42. The method of claim 33 further comprising the steps of:
generating user location data by a seat location at a local area network (LAN) gaming center as the user is positioned at the seat location; and
transmitting by the seat location, the user location data to at least one computer that is hosting a gaming event within the LAN gaming center.

43. The method of claim 42 wherein the wearable activity tracking device has a near field communication (NFC) chip and wherein the seat location has a NFC reader to communicate with the NFC chip within the wearable activity tracking device through a NFC wireless protocol to receive the user location data.

44. The method of claim 33 further comprising the steps of:
receiving activity data by a remote device, wherein the remote device receives the activity data from a plurality of sensors contained therein when the remote device is thrown a distance by the user, wherein the plurality of sensors comprise a global positioning system (GPS) tracking module, a gyroscope, and an accelerometer;
transmitting by the remote device, the activity data to the mobile electronic device through a short range wireless communication device of the remote device;
receiving the activity data by the mobile electronic device through the short range wireless communication device of the mobile electronic device that communicates with the short range wireless communication device of the remote device; and
transmitting the activity data from the mobile electronic device to the cloud data repository via the at least one of the wired communication device and the wireless communication device.

45. A method for tracking eSports data of a user comprising the steps of:
receiving at least one of physical fitness data and motion sensor data of the user, by a wearable activity tracking device that is worn by the user, wherein the wearable activity tracking device receives the at least one of the physical fitness data and the motion sensor data from at least one sensor contained therein;
transmitting the at least one of the physical fitness data and the motion sensor data from the wearable activity tracking device through a short range wireless communication device of the wearable activity tracking device;
receiving the at least one of the physical fitness data and the motion sensor data, by a mobile electronic device through a short range wireless communication device that communicates with the short range wireless communication device of the wearable activity tracking device;
transmitting the at least one of the physical fitness data and the motion sensor data from the mobile electronic device to a cloud data repository via at least one of a wired communication device and a wireless communication device;
receiving by the cloud data repository, the at least one of the physical fitness data and the motion sensor data;
receiving by the cloud data repository, game play data from a video game platform on which the user is playing a video game; and
transmitting the game play data and the at least one of the physical fitness data and the motion sensor data by the cloud data repository to at least one of a user viewable website portal and a computer for creating a customized video stream that is streamed on the Internet.

46. The method of claim 45 wherein the step of creating the customized video stream further comprises the step of creating an overlay that is superimposed over underlying images of the video game that the user is playing, wherein the overlay contains the at least one of the physical fitness data and the motion sensor data of the user.

47. The method of claim 45 wherein the at least one sensor within the wearable activity tracking device is at least one of an internal measurement unit (IMU) gyroscope, an accelerometer, a heart rate sensor, and a bioimpedance sensor.

48. The method of claim 45 wherein the short range wireless communication device of the mobile electronic device communicates with the short range wireless communication device of the wearable activity tracking device via a Bluetooth wireless protocol.

49. The method of claim 45 further comprising the steps of:
generating user gym data by an exercise device as the user exercises on the exercise device; and
transmitting by the exercise device, the user gym data to the cloud data repository.

50. The method of claim 49 wherein the wearable activity tracking device has a near filed communication (NFC) chip and wherein the exercise device has a NFC reader to communicate with the NFC chip within the wearable activity tracking device through a NFC wireless protocol to receive the at least one of the physical fitness data of the user and the motion sensor data of the user.

51. The method of claim 45 wherein the at least one sensor within the wearable activity tracking device is at least one of an internal measurement unit (IMU) gyroscope and an accelerometer, wherein the wearable activity tracking device receives the motion sensor data from the at least one of the IMU gyroscope and the accelerometer.

52. The method of claim 51 wherein the motion sensor data is used to track wrist movement of the user while the user is playing the video game.

53. The method of claim 52 further comprising the steps of:
transmitting the motion sensor data from the wearable activity tracking device through the short range wireless communication device of the wearable activity tracking device;
receiving by a video game controller, the motion sensor data through a short range wireless communication device that communicates with the short range wireless communication device of the wearable activity tracking device; and
translating the wrist movements of the user into one of mouse movements and game pad inputs.

54. The method of claim 45 further comprising the steps of:
receiving nutritional data by the mobile electronic device, wherein the nutritional data is input by the user through one of input keys and a touchscreen of the mobile electronic device;
transmitting the nutritional data from the mobile electronic device to the cloud data repository via the at least one of the wired communication device and the wireless communication device;
receiving by the cloud data repository, the nutritional data; and
transmitting the nutritional data by the cloud data repository to at least one of a user viewable website portal and a computer for creating a customized video stream that is streamed on the Internet.

55. The method of claim 54 wherein the step of creating the customized video stream further comprises the step of creating an overlay that is superimposed over underlying images of the video game that the user is playing, wherein the overlay contains the nutritional data of the user.

56. The method of claim 45 further comprising the steps of:
generating user location data by a seat location at a local area network (LAN) gaming center as the user is positioned at the seat location; and
transmitting by the seat location, the user location data to at least one computer that is hosting a gaming event within the LAN gaming center.

57. The method of claim 56 wherein the wearable activity tracking device has a near field communication (NFC) chip and wherein the seat location has a NFC reader to communicate with the NFC chip within the wearable activity tracking device through a NFC wireless protocol to receive the user location data.

58. The method of claim 45 further comprising the steps of:
receiving activity data by a remote device, wherein the remote device receives the activity data from a plurality of sensors contained therein when the remote device is thrown a distance by the user, wherein the plurality of sensors comprise a global positioning system (GPS) tracking module, a gyroscope, and an accelerometer;
transmitting by the remote device, the activity data to the mobile electronic device through a short range wireless communication device of the remote device;
receiving the activity data by the mobile electronic device through the short range wireless communication device of the mobile electronic device that communicates with the short range wireless communication device of the remote device; and
transmitting the activity data from the mobile electronic device to the cloud data repository via the at least one of the wired communication device and the wireless communication device.
